(19) United States
(12) Patent Application Publication
(10) Pub. No.: US 2011/0187102 A1
(43) Pub. Date: Aug. 4, 2011

(54) Energy System

(75) Inventor: Thorbjorn Sirseth, Bones (NO)

(73) Assignee: Ocean Wave Rocker AS, Paradis (NO)

(21) Appl. No.: 12/989,602

(22) PCT Filed: Dec. 17, 2008
(86) PCT No.: PCT/NO2008/000460

§ 371 Date: Jan. 7, 2011

(30) Foreign Application Priority Data
Apr. 24, 2008 (NO) 20081979
May 5, 2008 (NO) 20082085
Sep. 25, 2008 (NO) 20084089

(51) Int. Cl. H02P 9/04; F03B 13/18; F03B 13/22

(52) U.S. Cl. 290/42; 290/53; 60/502

(57) ABSTRACT

An ocean wave energy system is for generating power from ocean waves. The system comprises wall components defining one or more channels for guiding propagation of ocean waves therealong. Each channel has a first end for receiving the ocean waves and a second end remote from the first end. A float arrangement is disposed along each of the one or more channels between its first and second ends. Moreover, the float arrangement being arranged in size to progressively absorb energy from the ocean waves commencing with longest wavelength components in the waves and finishing with shortest wavelength components in the waves. The ocean wave energy system is capable of extracting energy efficiently and conveniently from ocean wave motion.

### FIELD OF THE INVENTION

The present invention relates to energy systems, for example to off-shore energy systems operable to generate electricity from energy conveyed in at least ocean waves. Moreover, the present invention also concerns methods of operating such energy systems.

### BACKGROUND OF THE INVENTION

It has been known for many years that energy associated with ocean wave motion is a potential source for generating clean and renewable electricity. Moreover, ocean waves are generated by a transformation of wind energy at an interface between the Earth's atmosphere and an upper water surface of an ocean. Wind energy itself derives from solar energy, by way of solar energy creating high-pressure and low-pressure spatial regions in the Earth's atmosphere. Thus, ocean wave energy derives originally from solar energy absorbed by the Earth.

Immediately below the upper water surface of the ocean, ocean wave energy flow occurs which has a magnitude which is approximately in practice five times greater than wind energy flow twenty metres over the upper surface of the ocean, and between ten and thirty times more dense than an intensity of solar energy incident upon the upper surface of the ocean. Thus, whereas solar energy provides a useful energy density approximately in a range of 100 to 200 W/m² on average in practice for many regions of the World (circa 800 W/m² in equatorial desert regions at noon maximum), wind energy provides an energy density in a range of approximately 400 to 600 W/m² on average in practice, and ocean wave energy provides an energy density in a range of approximately 2 to 3 kW/m² on average in practice. Along Norway's coast, it is estimated that an average ocean wave energy being dissipated is 70 kW/m; such an energy concentration is highly favourable for commercial ocean wave energy systems, especially when the relative cost of fossil fuels increases in future, for example as a general consequence of “peak-oil”. Coastlines elsewhere on Earth remote from Norway are also favourable locations for ocean wave energy systems, for example along coastlines of the Atlantic and Pacific Oceans. Unfortunately, electricity generation based on ocean wave energy has not hitherto been extensively employed because electricity generation from fossil fuels has been more economical. Low fossil fuel costs have tended to stifle development of alternative renewable energy technology, with the exception of hydroelectric power. Such stifling is believed to be a deliberate strategy by powerful oil interests. However, World demand for energy is increasing temporally exponentially and cannot be met solely by fossil fuels. Moreover, climate change issues dictate that future energy demand cannot be met by fossil fuels if severe climate change is to be averted.

In more recent years, electricity generation based on wind turbines has become more commonplace. In a majority of contemporary electricity generating facilities based on wind turbines, the wind turbines employed tend to be of one general configuration, namely each turbine includes an elongate cylindrical vertical tower having upper and lower ends. The lower end is anchored to foundations and the upper end has mounted thereto a nacelle machine housing whose elongate axis is substantially perpendicular to that of the elongate cylindrical tower. At one end of the machine housing is mounted a turbine comprising a rotatable central hub to which is attached typically in a range of two to three radially-projecting turbine blades. The blades are elongate and are often implemented to be rotatably adjustable about their elongate axes relative to the hub to enable a pitch angle of the blades to be adjusted in operation, for example for mains frequency synchronization purposes when generating electrical power for feeding onto a polyphase electrical distribution network. The housing includes a gearbox for optimally coupling torque experienced at the hub as a result of wind acting upon the blades to output torque to drive an electrical generator. The machine housing is rotatably adjustable in operation relative to the cylindrical tower for orientating the wind turbine most advantageously in respect of prevailing wind direction. Wind turbines for electricity generation have been pioneered, for example, by Vestas AS (Denmark) and Gamesa SA (Spain) amongst other commercial companies. Such wind turbines have become generally used in electricity generating systems because they represent an optimized compromise between cost and power generating ability, especially when wind turbine rotor-spans approach 150 metres. Wind turbines with rotor-spans around 50 metres are less cost effective for a given electricity generating capacity than wind turbines having 150 metre rotor-spans, and wind turbines with rotor-spans in excess of 150 metres become problematical during construction and deployment.

At present, many diverse schemes have been proposed for generating electricity from ocean wave energy. However, in contradistinction to aforementioned wind turbines for electricity generation, a generally preferred type of ocean wave energy system which has clearly shown itself capable of providing best electricity energy generation performance for a given capital investment has not yet emerged.

Ocean-deployed systems are required to survive severe environmental conditions. Sea water includes a cocktail of metallic salts which react with ocean structures, namely requiring the structures to be regular maintained, for example by painting metallic structures or resurfacing concrete structures. Ocean wave energies in severe storm conditions greatly exceed average ocean wave energies, for example by as much as several orders of magnitude in hurricane conditions, thereby requiring ocean-deployed systems to be robustly constructed and yet be able to efficiently convert ocean wave energy to electricity in non-storm conditions. Wind turbines typically are not subject to such extremes of operating conditions, although hurricanes in Asia prevent such turbines from being deployed in many off-shore environments.

Many earlier proposed ocean wave energy systems have utilized various types of floats whose motion in response to ocean waves acting thereupon is used to pump hydraulic fluid or gas through slender flexible pipes to drive electrical generators for producing electrical power. A problem with such systems is that the floats have been utilized ineffectively, for example 10% efficiency, for collecting available ocean wave energy; moreover, energy losses occurring in such systems when pumping viscous hydraulic fluid or gas through slender pipes reduces efficiency of the systems and hence adversely affects their economic viability.

Locating ocean wave energy systems on land along coastlines at least partly addresses problems encountered with mounting apparatus off-shore, namely remote from coastlines. However, locating such systems on land near coast-lines is often disliked for aesthetic reasons, namely ruination of areas of outstanding natural beauty, as well as coastlines are often expensive on account their desirability for coastal residences which often command high prices. Deployment of wind-turbines on land along coastlines, for example, is disliked because such turbines are susceptible to generating spurious radar reflections which potentially interferes with operation of defence radar installations. Such defence issues are especially relevant for the United Kingdom for example which therefore favours nuclear power with all its inherent problems of radioactive waste storage and disposal.

An early French patent which addressed extraction of energy from ocean waves was associated with an inventor Girard. The inventor Girard observed how ocean waves were able to lift large ships. In the 19^{th} Century, cyclical motion of floats to mechanically pump fluids or operate other types of mechanical apparatus was proposed. Power coupling from the floats was achieved by way of toothed rods and toothed cogs. In 1892, an author A. W. Stahl published a 57-page article with title: The Utilization of Power of Ocean Waves.

In 1910, at Royan near Bordeaux in France, Mr Bochaux-Praceique supplied his house with 1 kW electricity generated from a turbine which was driven by air provided from a swinging water column having an upper gaseous region and a lower region filled with water in communication with an adjacent ocean. When a water level in the column varied in response to ocean wave motion, air was pumped into and out of the upper region of the column via the turbine. A swinging-water-column power generating system was more recently tested in year 1999 in a pilot project on the island of Pico in the Azores. The project was supported by the JOULE program of the European Union (EU), and was managed by Instituto Superior Técnico in Portugal. The power generating system had a concrete construction and a water surface area of 144 m². An electricity generating turbine was utilized having a generating capacity of 400 kW. In addition to being a pilot project, an aim of the project was to provide the island of Pico with 8% to 9% of its annual electricity power consumption for its 15000 inhabitants using the power generating system.

In 1974, a Scottish inventor Stephen Salter published an article describing an apparatus which later to become known as the “Salter Duck” or “Edinburgh Duck”. Stephen Salter's invention concerns a float which resembles a tapered wedge in cross-section, the float having a first tapered end and a second thicker end. The float is pivotally mounted at its second thicker end, such that its first tapered end is able to bob up and down in response to ocean waves impinging thereupon in operation. Pivoting of a series of such floats mutually mounted at their thicker ends to a common axle is employed to pump hydraulic fluid for driving an electricity generating turbine. In operation, a series of such floats are disposed along an off-shore region near a coastline. Wave tank experiments identify that a region of water behind a row of such floats is devoid of waves, indicating that the series of floats is efficient to at least one of collect ocean wave energy and reflect ocean wave energy.

Ocean wave energy systems have been proposed wherein breaking ocean waves propagating in an ocean are guided up a ramp and overshoot the ramp into a collection reservoir at a height greater than a sea level of the ocean. Water collected in the collection reservoir is then guided via an electricity generating turbine to the ocean. Such power generating systems were first proposed in the 1970's, for example as described in a United Kingdom patent no. 741 494. More recently, similar types of energy system have been proposed in floating form for use off-shore, thereby adapting to tides and wave height variations by adjusting buoyancy of these off-shore energy systems. These floating systems need a relatively high wave height to function efficiently and are therefore less effective in relatively tranquil ocean conditions. Moreover, high wave amplitudes are often encountered in remote regions at considerable distances from where power is likely to be consumed, namely major cities; transmission line costs are then significant and adversely affect economic viability of such systems.

Pelamis Wave Power Ltd. (Pelamis Wave Power Ltd., 104 Commercial Street, Edinburgh EH6 6NF, Scotland) has developed a Pelamis wave energy system as described in an international PCT patent application no. WO 0017519 A1 (Yemm & Pizer), as also described in U.S. Pat. No. 6,476,511. In the Pelamis wave energy system, a series of elongate floats are disposed in a linear sequence substantially perpendicularly in operation to a direction of waves in an ocean environment. Relative movement of the elongate floats in response to ocean waves acting upon the floats is employed in operation to pump hydraulic fluid which provides mechanical actuation of electrical generators housed within the floats. Electrical power generated within the floats is conveyed via a submerged cable to land for consumption. According to disclosure made by Pelamis Wave Power Ltd., the Pelamis wave energy system only extracts about 10% of wave power flowing in waves along the floats. Moreover, in relatively high wave amplitudes, the Pelamis wave energy system is not expected to be functional but configured in a survival mode which enables it to survive severe weather conditions.

Many other types of ocean wave energy systems are described in published patent specifications. However, there presently appears to be a lack of any particular technical implementation of ocean wave system which clearly provides best compromise for electricity generating performance in respect of a given commercial investment, namely:
(a) which is capable of efficiently generating electricity in diverse ocean wave conditions;
(b) which is robust enough to survive extreme ocean storm conditions;
(c) which is capable of resisting a harsh corrosive environment encountered in off-shore ocean locations; and
(d) which is relatively straightforward to maintain and repair.

Until problems elucidated above are addressed, use of nuclear power stations and fossil-fuel-burning power stations to generate electricity supplemented with renewable electricity generated by wind-turbines will be a preferred option for commercial electrical energy supply companies; such nuclear and fossil-fuel burning power stations are beneficially operable to compensate for a loss of generating capacity which occurs when wind-conditions do not allow for wind-turbine electrical energy generation.

### SUMMARY OF THE INVENTION

An object of the present invention is to provide an ocean wave energy system which seeks to at least partially address problems encountered with aforementioned known energy systems.

According to a first aspect of the invention, there is provided an ocean wave energy system as defined in appended claim 1: there is provided an ocean wave energy system for generating power from ocean waves, characterized in that the system comprises:
(a) a plurality of wall components defining one or more channels for guiding propagation of ocean waves therealong, each channel having a first end for receiving the ocean waves and a second end remote from the first end; and
(b) a float arrangement and/or submerged movable component arrangement disposed along each of the one or more channels between its first and second ends, the float arrangement and/or movable components arrangement being arranged in size to progressively absorb energy from the ocean waves commencing with longest wavelength components in the waves and finishing with shortest wavelength components in the waves.

The invention is of advantage in that the one or more channels in combination with the float arrangement and/or the movable component arrangement are capable of operating cooperatively together to efficiently collect energy from ocean waves whilst simultaneously constituting a robust structure for surviving adverse weather conditions.

The channels of the present invention are intended for off-shore operation whereat wave breaking does no substantially occur in contradistinction to contemporary known wave ramp systems with channels whereat full breaking of waves is utilized as part of an energy collection process employed.

Beneficially, the ocean wave system includes a power coupling arrangement associated with the float arrangement, the power coupling arrangement being mounted in respect of the plurality of wall components, the power coupling arrangement being operable to generate power by converting motion of the float arrangement in response to the ocean waves propagating along the one or more channels. A float arrangement constitutes a simple and effective approach to interface to wave motion.

Beneficially, in the ocean wave energy system, the float arrangement includes one or more floats for each of the one or more channels, the one or more floats being selectively deployable for controlling wave frequency ranges from which energy is extracted from ocean waves propagating along the one or more channels. Selective deployment of the floats enables the system to be optimized to various ocean wave amplitude and frequency conditions.

Beneficially, in the ocean wave energy system, the plurality of wall components include buoyancy arrangements for enabling their height and/or inclination relative to an ocean surface to be adjusted in operation. Adjustment of the height and/or inclination of the wall components enables operation of the system to be optimized for most efficient energy collection from received ocean waves in response to diverse ocean wave conditions.

Beneficially, the plurality of wall components and/or bridging members coupled between the wall components, are provided with gyroscopic stabilization to resist angular rocking of the wall components when in operation. More optionally, the gyroscopic stabilization is synergistically also employed for energy storage by way of inertial energy storage for temporally smoothing out variations of electrical power from the ocean wave energy system.

Beneficially, in the ocean wave energy system, the one or more channels are formed in shape along their length for concentrating propagating ocean wave energy therealong in operation. Such concentration of propagating ocean wave energy is susceptible to being achieved, for example, by arranging the channels to have a tapered form and/or including various submerged features causing the waves which have propagated along the channels to break.

Beneficially, in the ocean wave energy system, there are provided one or more submerged features for causing ocean waves received at the system to break and/or spatially synchronize as they enter into the one or more channels. Such one or more submerged features include, for example, submerged projections associated with the wall components and various forms of submerged baffles, members and plates.

Beneficially, the ocean wave energy system includes one or more submerged features along the one or more channels for at least one of:
(a) extracting energy from cyclical water movement associated with an underwater energy field of waves propagating along the channels; and
(b) causing ocean waves propagating along the channels to break for assistance energy collection by the float arrangement from the one or more channels.

More beneficially, the one or more submerged features are dynamically adjustable in response to ocean wave amplitude and wavelength characteristics as received by the system.

Beneficially, in the ocean wave energy system, the plurality of wall components is more massively constructed in a region thereof in a vicinity of the first end in comparison to said second end. Such implementation is economical in terms of materials employed to construct the system, thereby improving is electricity generating performance relative to its construction cost whilst also addressing issues of system robustness to adverse weather conditions in operation.

Beneficially, in the ocean wave energy system, transverse members are disposed at least under the one or more channels and over the one or more channels for maintaining the plurality of wall components in a spaced-apart configuration for defining the one or more channels. More beneficially, the transverse members allow for some degree of freedom of movement of the plurality of wall components to accommodate to stresses arising within the system in response to ocean wave movement, thereby rendering the system to be a generally flexible structure.

More beneficially, the ocean wave energy system includes additional facilities mounted on at least one of said transverse members and the plurality of wall components, the additional facilities including at least one of:

(a) cranes for servicing the float arrangement of the one or more channels (50);
(b) wind turbines for wind power generation;
(c) solar energy collection arrangements for solar power generation;
(d) one or more helicopter landing pads.

Beneficially, the ocean wave energy system includes additional facilities at the second end of the one or more channels (50), the additional facilities including at least one of:

(a) aquaculture;
(b) harbour facilities;
(c) personnel facilities;
(d) visitor/tourist facilities.

Beneficially, the ocean wave system utilizes a siphon principle for energy extraction from movement of the float arrangement: in the ocean wave energy system, the power coupling arrangement includes one or more primary liquid tanks mounted in respect of the one or more wall components, one or more secondary liquid tanks mounted in respect of floats of the float arrangement, and one or more siphon ducts operable to fluidly couple between respective the one or more primary liquid tanks and the one or more secondary liquid tanks, the one or more siphon ducts including one or more turbines for extracting energy from liquid flow occurring in operation within the one or more ducts in response to movement of the one or more floats relative to their respective one or more wall components.

Alternatively, or additionally, the ocean wave energy system is implemented such that the power coupling arrangement is operable to utilize at least one of:
(a) a configuration of levers and/or pulleys for coupling movement of floats of the float arrangement to a power generator arrangement; and
(b) a configuration of permanent electromagnets and electrical coils mounted in respect of floats (100) of the float arrangement and mounted in respect of the one or more wall components (20) so that movement of the floats (100) in operation relative to the one or more wall components (20) generates electrical power directly.

Optionally, in the ocean wave energy system, at least one of the plurality of wall components includes one or more energy storage arrangements for storing a portion of energy generated by the system, and for converting energy stored therein into electricity when the system is subject to reduced wind speed and/or ocean wave amplitude for maintaining a more stable supply of energy from the system when in operation. Reduced wind speed corresponds to, for example, less than a threshold of 5 metres/second, more preferably less than 2 metres/second. Moreover, reduced ocean wave amplitude corresponds to, for example, less than 0.5 metres from ocean wave peak to ocean wave trough.

According to a second aspect of the invention, there is provided an energy peninsula as claimed in appended claim 15: there is provided an energy peninsula including at least one end coupled to at least one land region, the energy peninsula including at least one ocean wave energy system pursuant to the first aspect of the invention.

According to a third aspect of the invention, there is provided a method of generating power from ocean waves in an ocean wave energy system pursuant to the first aspect of the invention, the method being as defined in appended claim 16: there is provided a method of generating power from ocean waves in an ocean wave energy system pursuant to the first aspect of the invention, characterized in that the method includes steps of:
(a) using a plurality of wall components defining one or more channels for guiding propagation of ocean waves therealong, each channel having a first end for receiving the ocean waves and a second end remote from the first end; and
(b) using a float arrangement arranged in suitable size and disposed along each of the one or more channels between its first and second ends and/or using a submerged movable component arrangement disposed along each of the one or more channels between its first and second ends, progressively absorbing energy from the ocean waves commencing with longest wavelength components in the waves and finishing with shortest wavelength components in the waves.

According to a fourth aspect of the invention, there is provided a method of controlling operation of an ocean wave energy system pursuant to the first aspect of the invention, the method being defined in appended claim 17: there is provided a method of controlling operation of an ocean wave energy system pursuant to the first aspect of the invention, characterized in that the method includes steps of:
(a) sensing a frequency spectrum of wave components present in ocean waves received at the system;
(b) selectively deploying one or more floats of a float arrangement in response to the frequency spectrum, taking into consideration spatial wavelength response characteristics of the one or more floats to wave components present in the received ocean waves.

Beneficially, the method includes an additional step of selectively retracting one or more of the floats to a submerged state when the one or more of the floats are not required in respect of the sensed frequency spectrum.

According to a fifth aspect of the invention, there is provided a software product stored on a data carrier and capable of being machine read and executed on computing hardware for implementing a method pursuant to the third or fourth aspects of the invention.

According to a sixth aspect of the invention, there is provided a method of extracting power in a power coupling arrangement including one or more primary liquid tanks mounted in respect of one or more wall components, one or more secondary liquid tanks mounted in respect of floats of a float arrangement, and one or more siphon ducts operable to fluidly couple between respective said one or more primary liquid tanks and the one or more secondary liquid tanks, the method including a step of:

using one or more turbines included in the one or more siphon ducts for extracting energy from liquid flow occurring in operation within the one or more ducts in response to movement of the one or more floats relative to their respective one or more wall components.

According to a seventh aspect of the present invention, there is provided a bridge structure linking two land regions together, the bridge structure having disposed therealong an ocean wave energy system pursuant to the first aspect of the present invention.

Features of the invention are susceptible to being combined in any combination without departing from the scope of the invention as defined by the appended claims.

### DESCRIPTION OF THE DIAGRAMS

Embodiments of the present invention will now be described, by way of example only, with reference to the following diagrams wherein:

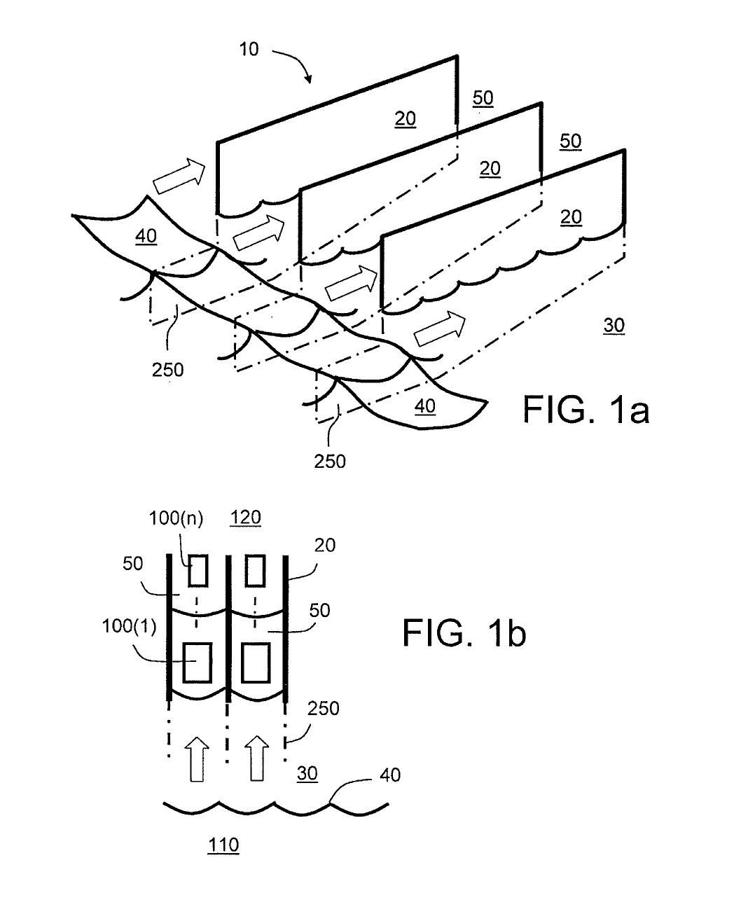

FIG. 1a (FIG. 1a) is a schematic perspective diagram of planar wall components of an ocean wave energy system pursuant to the present invention;

FIG. 1b (FIG. 1b) is a schematic plan diagram of the planar wall components forming channels therebetween for accommodating in a range of 1 to n floats within each of the channels, n being an integer of value two or greater;

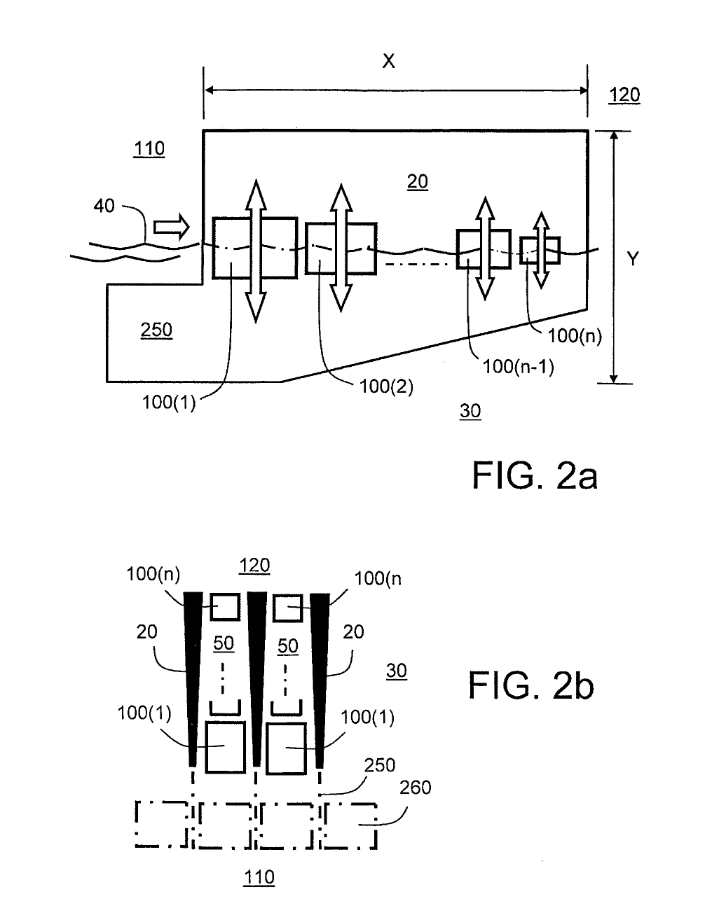

FIG. 2a (FIG. 2a) is a schematic side view of one of the planar wall components of FIG. 1a illustrating a series of floats tethered alongside the planar wall component, the floats being of progressively diminishing length for efficiently responding to various wavelengths of ocean wave energy propagating along the channels;

FIG. 2b (FIG. 2b) is a schematic plan diagram illustrating wave conditioning features included at an entrance region of the channels;

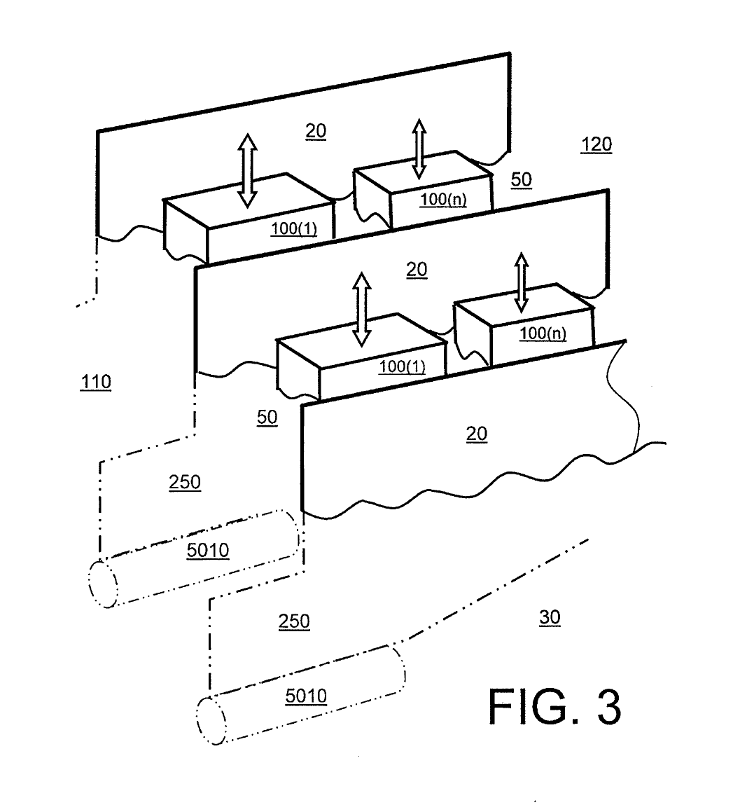

FIG. 3 (FIG. 3) is a schematic perspective diagram of the planar wall components shown in FIGS. 1a to 2b forming channels therebetween, the channels accommodating floats which are operable to move up and down in response to ocean wave energy being guided by the planar wall components along their respective channels;

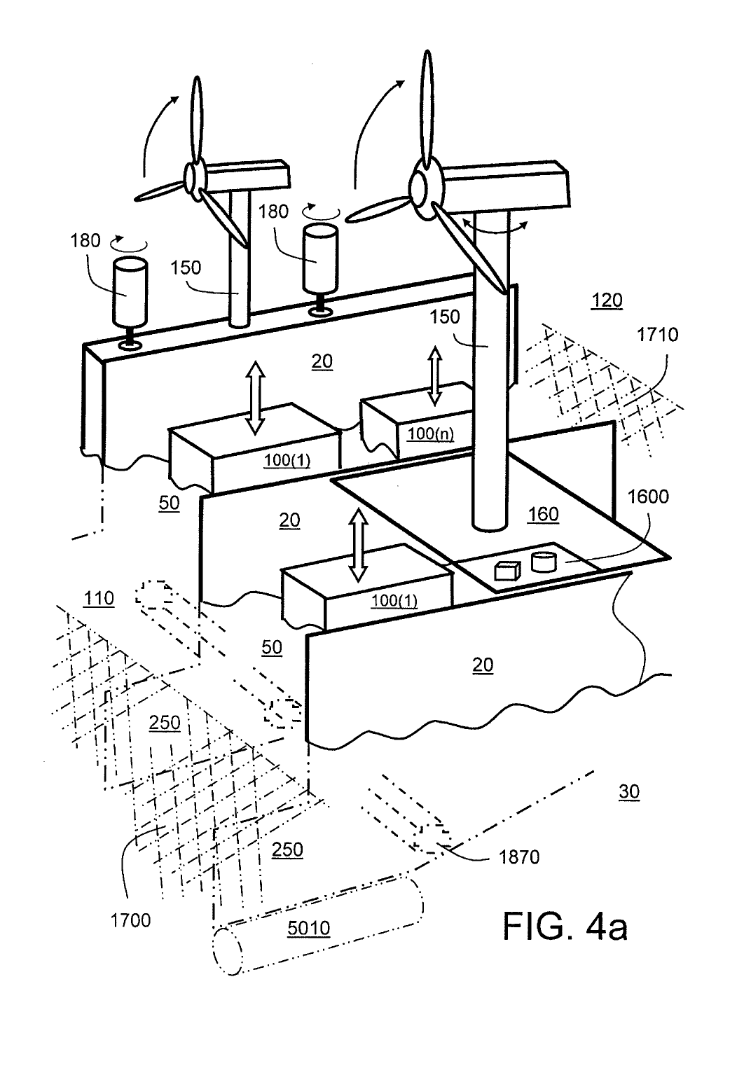

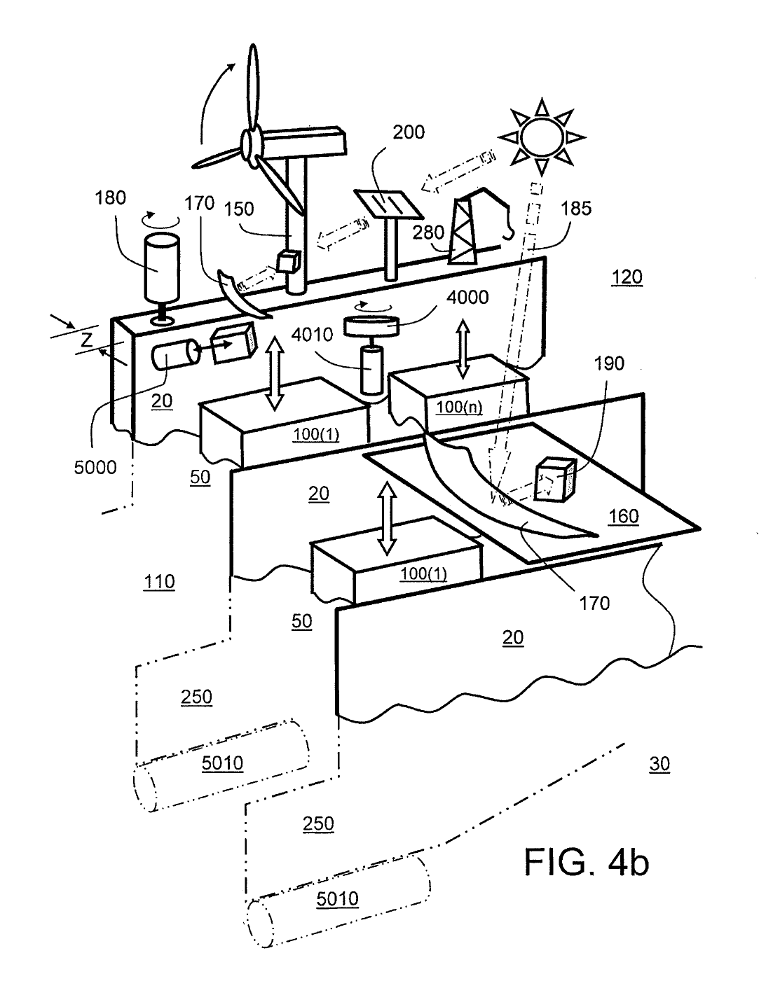

FIG. 4a (FIG. 4A) is a schematic perspective diagram of the planar wall components shown in FIGS. 1a to 2b forming channels therebetween, the planar wall components being adapted to accommodate one or more wind turbines, and/or the planar wall components being provided with bridging components onto which one or more wind turbines are accommodated;

FIG. 4b (FIG. 4B) is a schematic perspective diagram of the system of FIG. 1a equipped with wind turbines and solar energy collectors as well as apparatus for generating electricity from ocean wave energy;

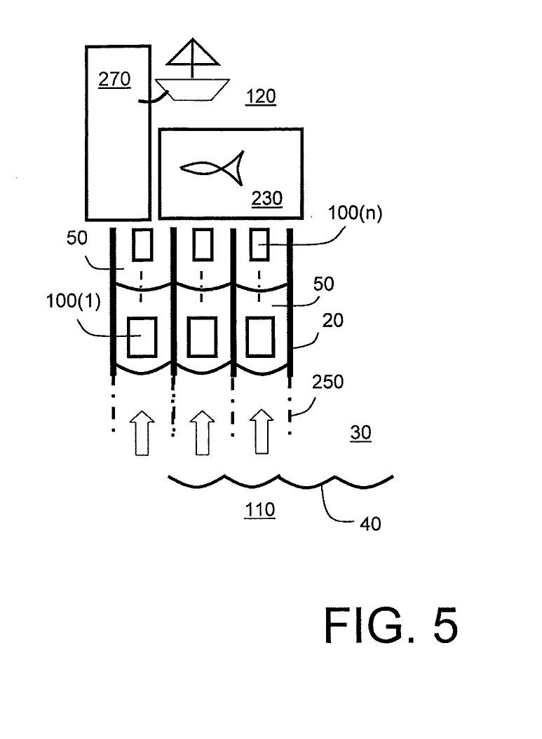

FIG. 5 (FIG. 5) is a plan-view schematic illustration of the system of FIG. 1a equipped with aquaculture facilities and port facilities for receiving ships and boats;

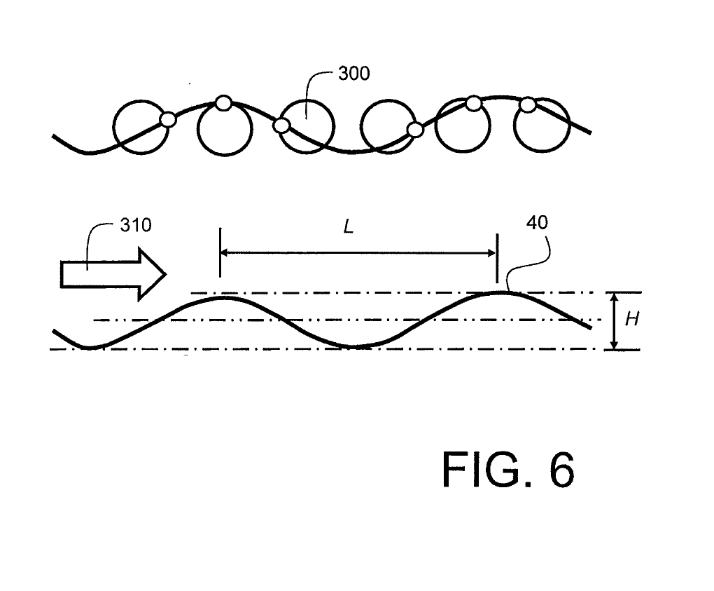

FIG. 6 (FIG. 6) is a schematic illustration of substantially circular surface water movement occurring during ocean wave propagation;

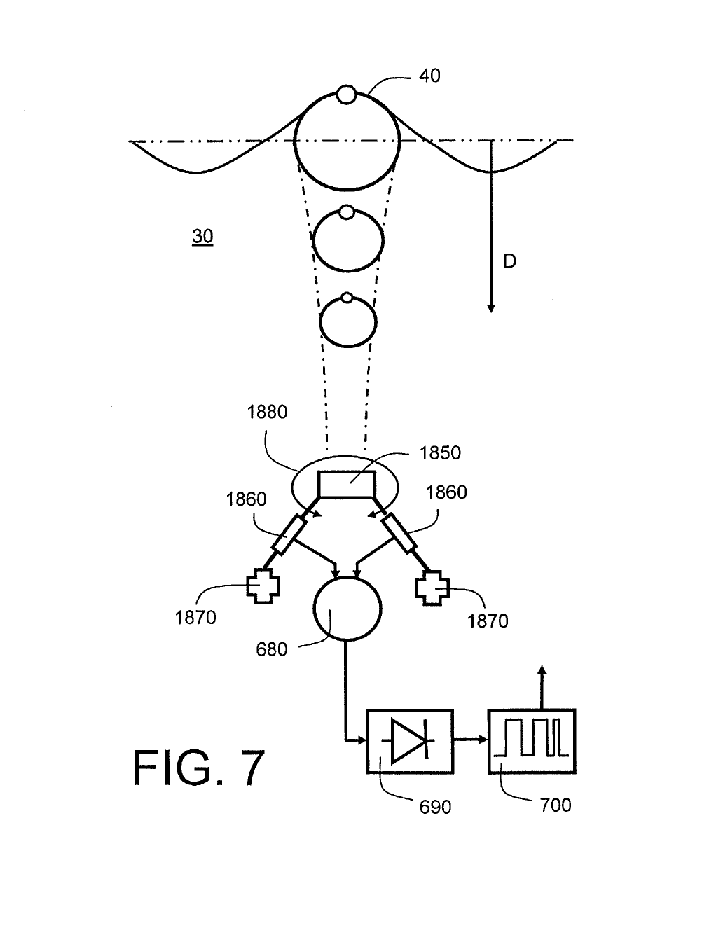

FIG. 7 (FIG. 7) is a schematic illustration of diminishing circular water movement associated with ocean wave propagation as function of water depth, together with a schematic representation of an apparatus operable to extract ocean wave energy to generate electricity from components of ocean wave energy present at a distance under water;

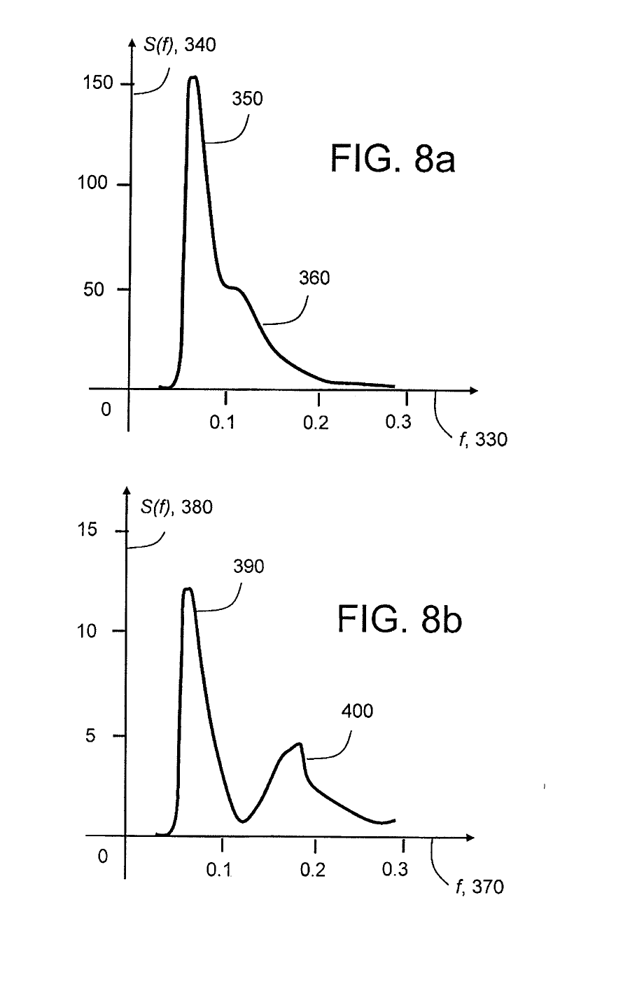

FIG. 8a (FIG. 8a) is a frequency spectrum of ocean wave energy in conditions of considerable swell;

FIG. 8b (FIG. 8b) is a frequency spectrum of ocean wave energy in conditions of mixed swell and wind-induced waves of higher frequency than swell waves;

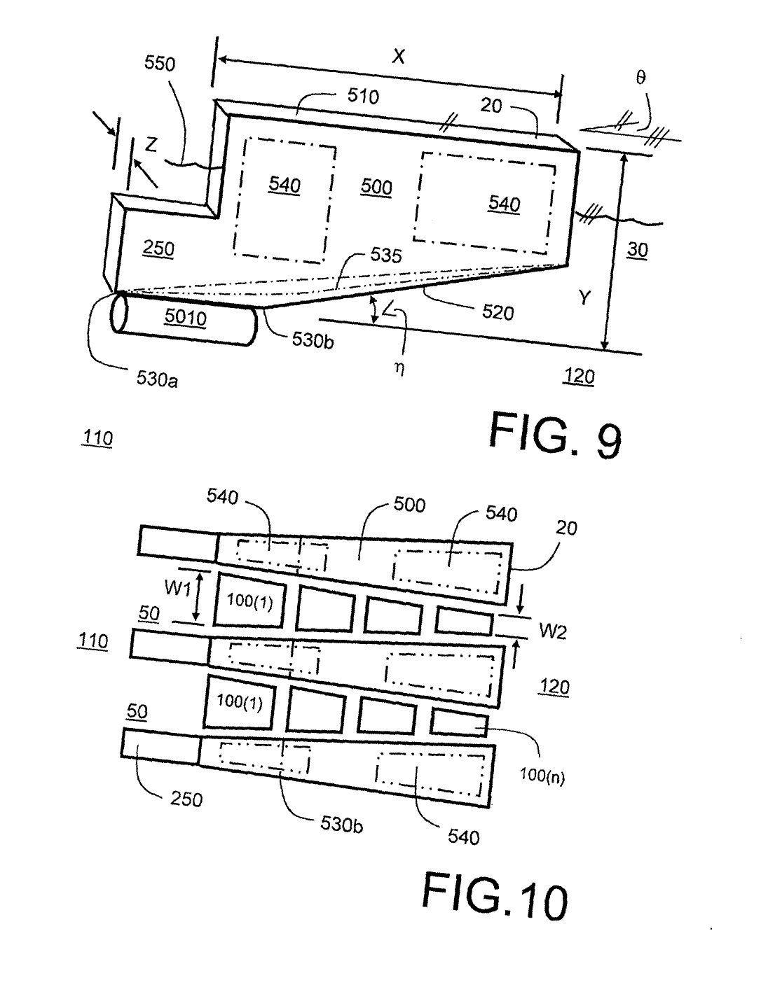

FIG. 9 (FIG. 9) is a schematic side view of a planar wall component employed to construct the system illustrated in FIGS. 1a, 4a and 4b;

FIG. 10 (FIG. 10) is schematic plan view of the system of FIG. 1a, wherein the planar wall components are proportioned so that channels formed therebetween are of a tapered profile for concentrating ocean wave energy propagating in operation along the channels;

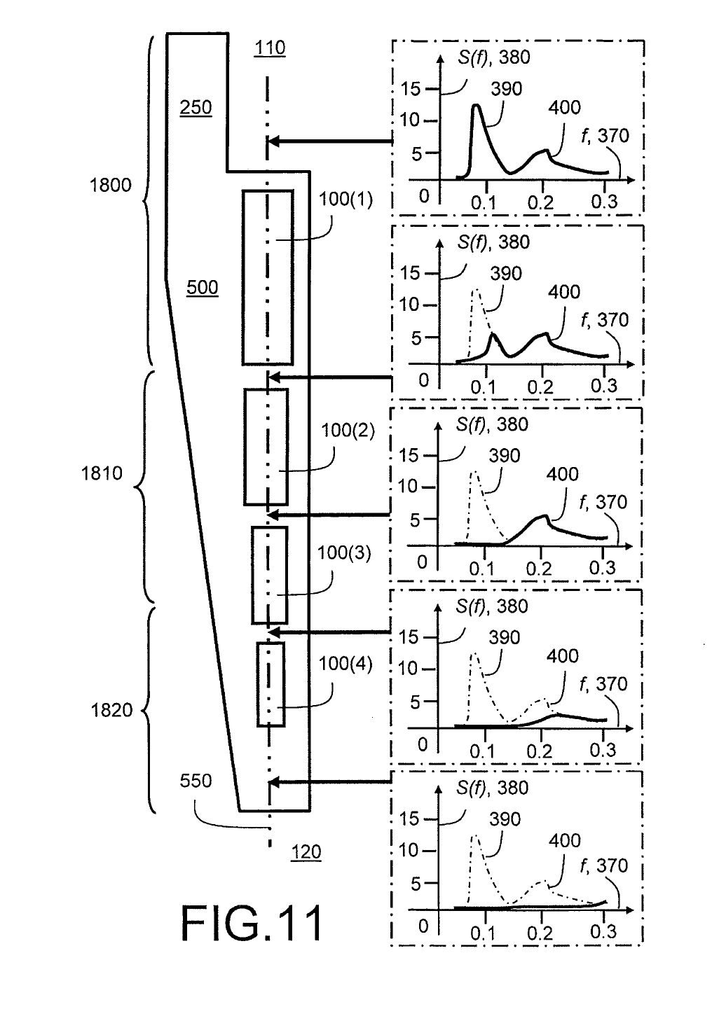

FIG. 11 (FIG. 11) is an illustration of progressive ocean wave energy extraction occurring at various ocean wave frequencies along channels of the system of FIGS. 1a, 4a and 4b;

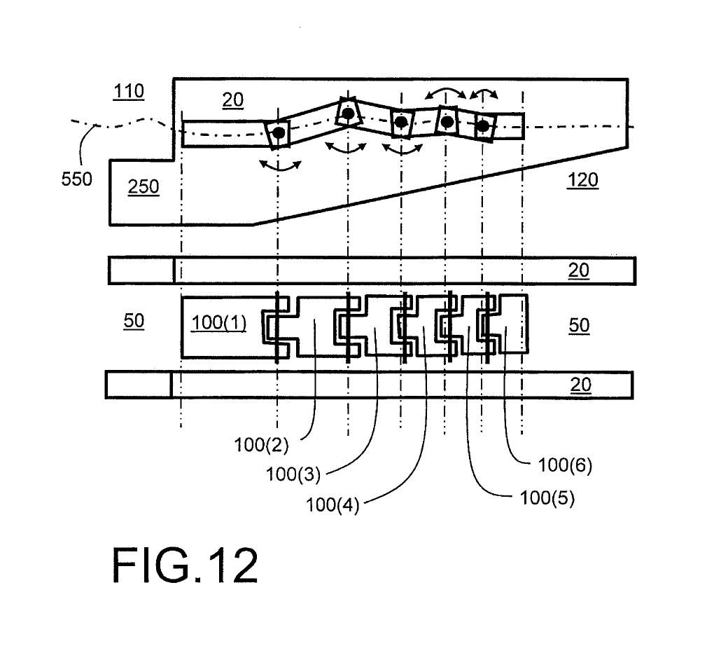

FIG. 12 (FIG. 12) is an illustration of an implementation of a hinged multi-section float for use in the channels of the system as illustrated in FIGS. 1a, 4a and 4b;

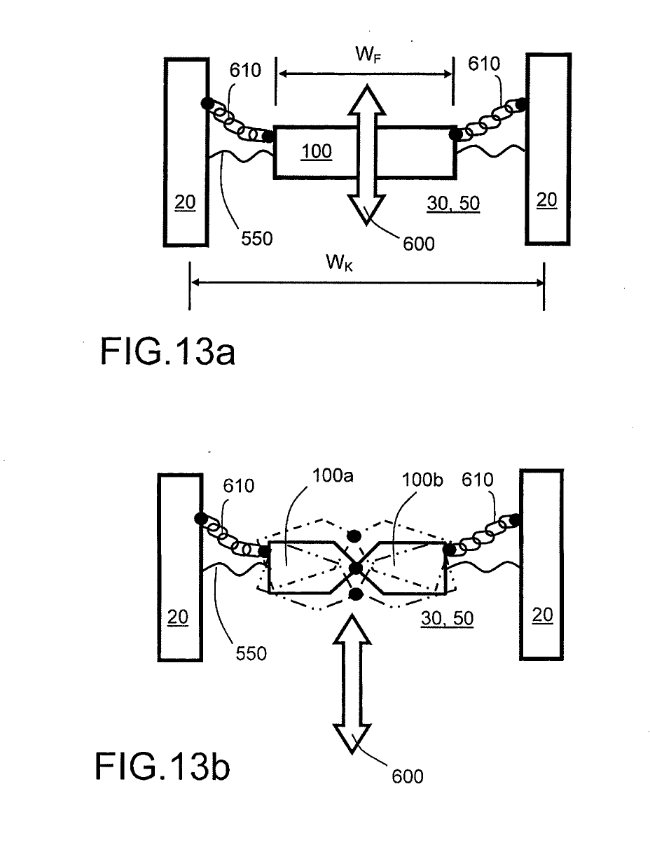

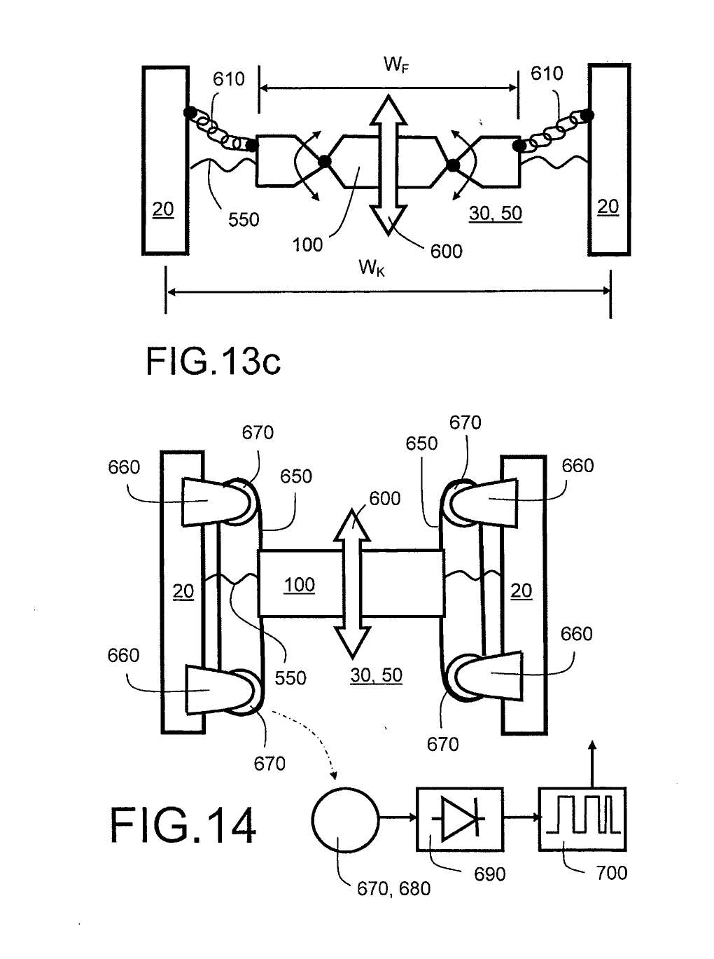

FIG. 13a (FIG. 13a) is a schematic diagram of tethering applied to floats within channels of the system in FIGS. 1a, 4a and 4b, the tethering being operable to maintain the floats substantially centred within their respective channels;

FIG. 13b (FIG. 13b) is a schematic diagram of an implementation of a float for use in the channels of the system illustrated in FIGS. 1a, 4a and 4b, the float including in a transverse direction across the channels two sub-floats mutually pivotally coupled together;

FIG. 13c (FIG. 13c) is a schematic diagram of tethering applied to floats within channels of the system in FIGS. 1a, 4a and 4b, the float including in a transverse direction across the channels three sub-floats mutually pivotally coupled together;

FIG. 14 (FIG. 14) is a schematic diagram of an arrangement employing pulleys and bands, alternatively belts and/or chains, for coupling energy associated with movement of a buoyant float within a channel of the system of FIGS. 1a, 4a and 4b to generate electrical power;

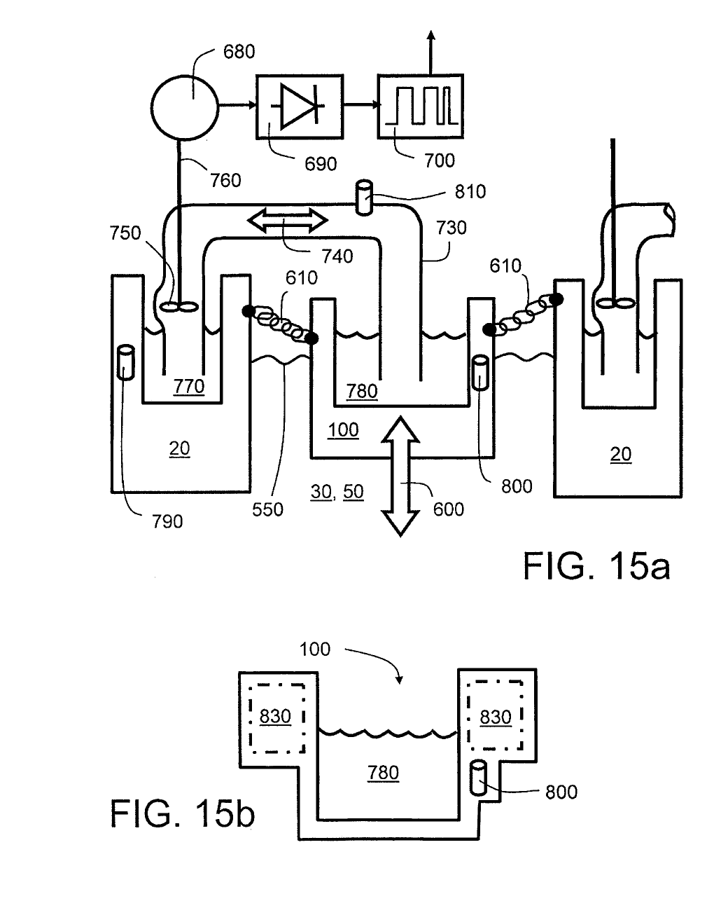

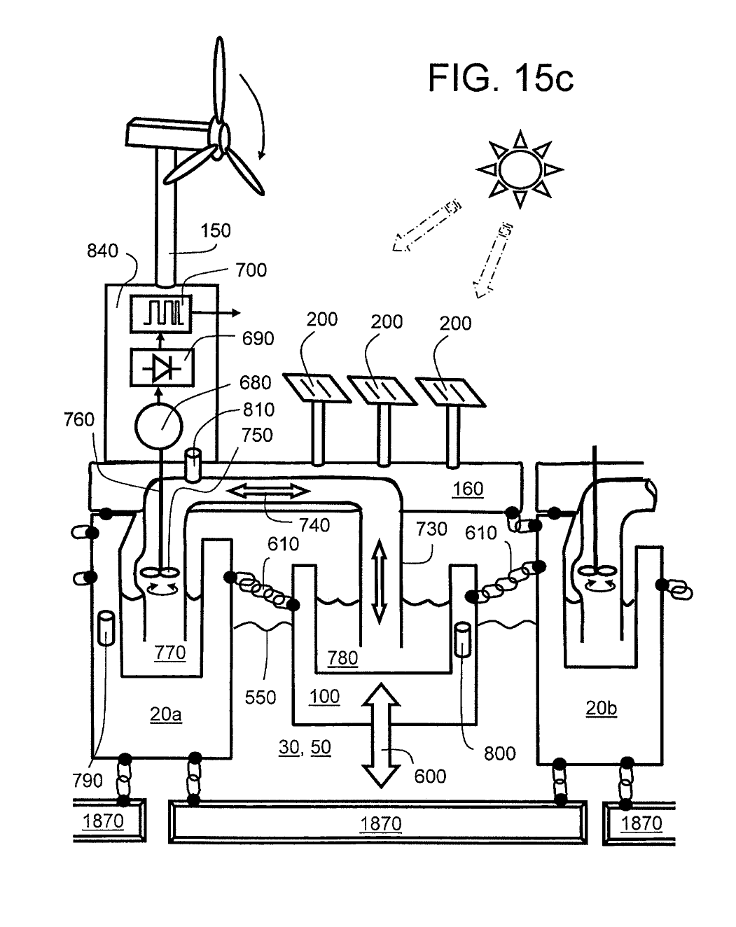

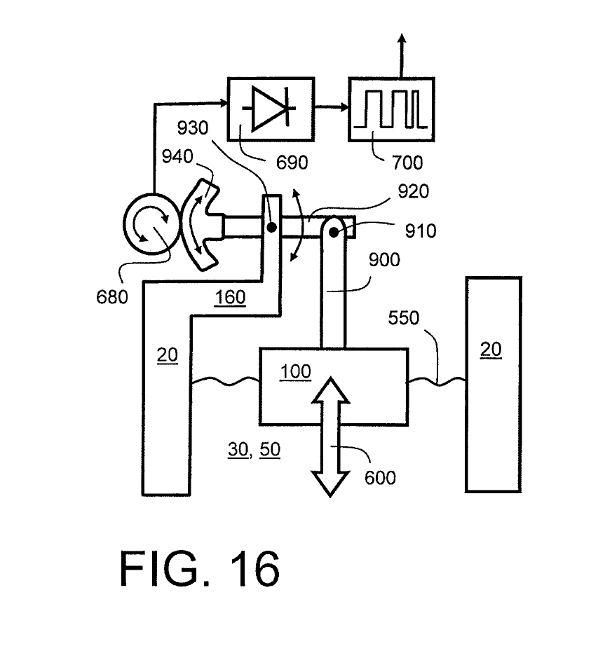

FIG. 15a (FIG. 15a) is a schematic diagram of an arrangement employing a siphon applied to floats within channels of the system in FIGS. 1a, 4a and 4, the siphon enabling the arrangement to employ relatively few moving parts and provide flexibility for the float to move laterally as well as up and down in operation without work-hardening or wearing component parts, thereby providing a durable and reliable energy coupling configuration;

FIG. 15b (FIG. 15b) is a schematic cross-section diagram of a configuration for a float for use with the arrangement of FIG. 15a;

FIG. 15c (FIG. 15c) is a schematic cross-section diagram of a configuration for a float for use with the arrangements of FIGS. 15a and 15b, the configuration of FIG. 15c synergistically allowing for mounting of wind turbines and solar collectors, as well as providing for a robust construction to resist ocean storm conditions wherein the floats are protected by transverse members employed in construction;

FIG. 16 (FIG. 16) is a schematic representation of an arrangement employing a lever configuration applied to floats within channels of the system in FIGS. 1a, 4a and 4b, the lever configuration providing an efficient and simple approach to converting energy associated with movement of the float within the channel of the system to electricity;

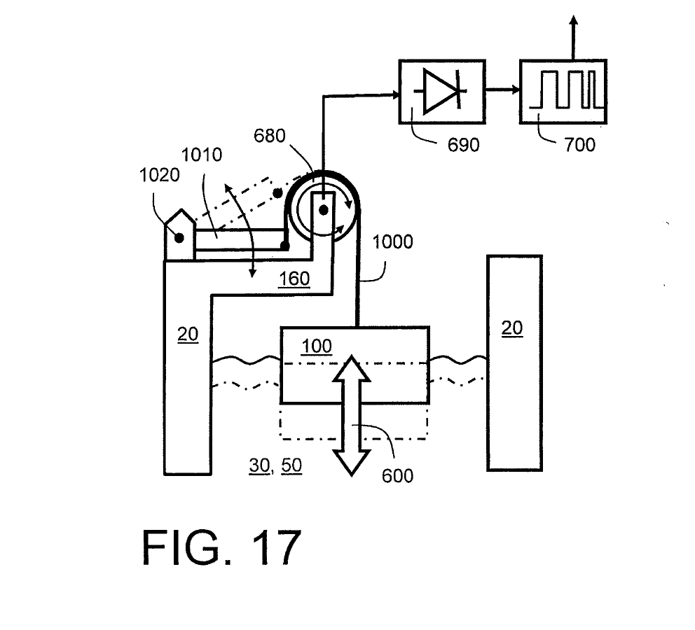

FIG. 17 (FIG. 17) is a schematic diagram of a simple counter-balanced arrangement for use with the system of FIGS. 1a, 4a and 4b for providing an efficient and simple approach to converting energy associated with movement of the float within the channel of the system to electricity;

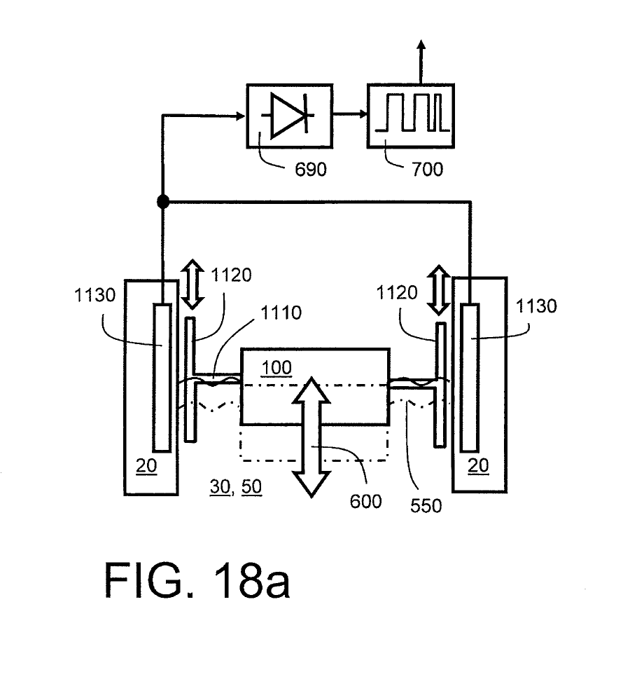

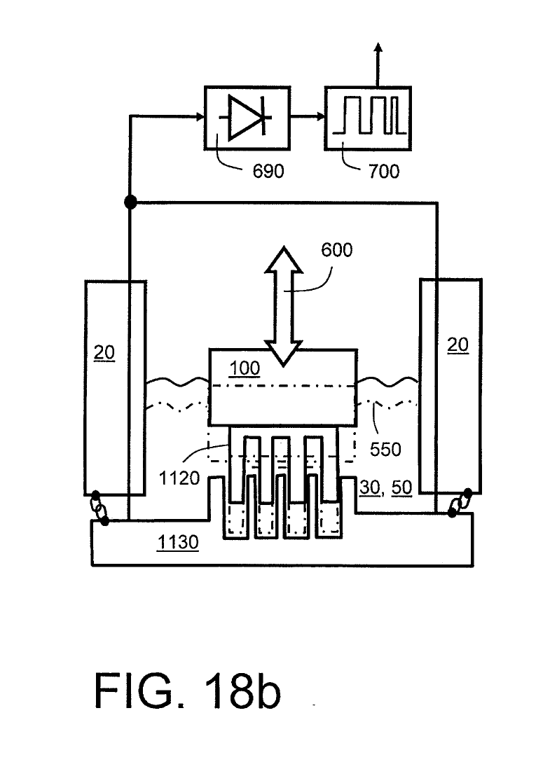

FIG. 18a (FIG. 18a) is a schematic diagram of a simple direct electromagnetic coupling arrangement for use with the system of FIGS. 1a, 4a and 4b for providing an efficient manner of generating electrical energy from movement of the float within the channel of the system, the arrangement having a minimum of moving parts for enhancing reliability in operation;

FIG. 18b (FIG. 18b) is a schematic diagram of an alternative simple direct electromagnetic coupling arrangement for use with the system of FIGS. 1a, 4a and 4b for providing an efficient manner of generating electricity from movement of the float within the system, the float including a magnetic arrangement on its submerged underside with electromagnetic induction coil mounted on a transverse member beneath the float;

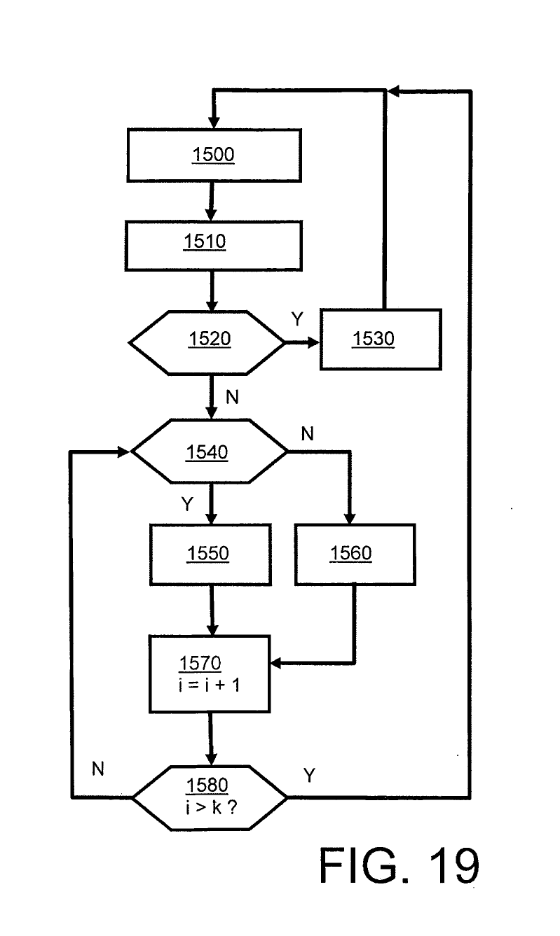

FIG. 19 (FIG. 19) is a flow chart of a method of controlling the system of FIGS. 1a, 4a and 4b;

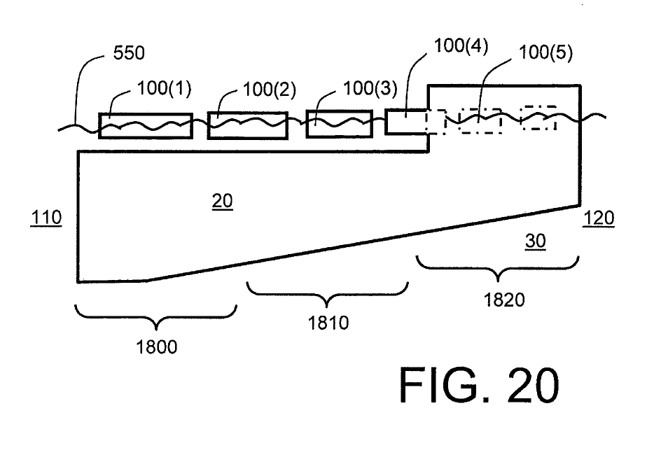

FIG. 20 (FIG. 20) is a schematic diagram of an alternative form for a planar wall component for use within the systems of FIGS. 1a, 4a and 4b;

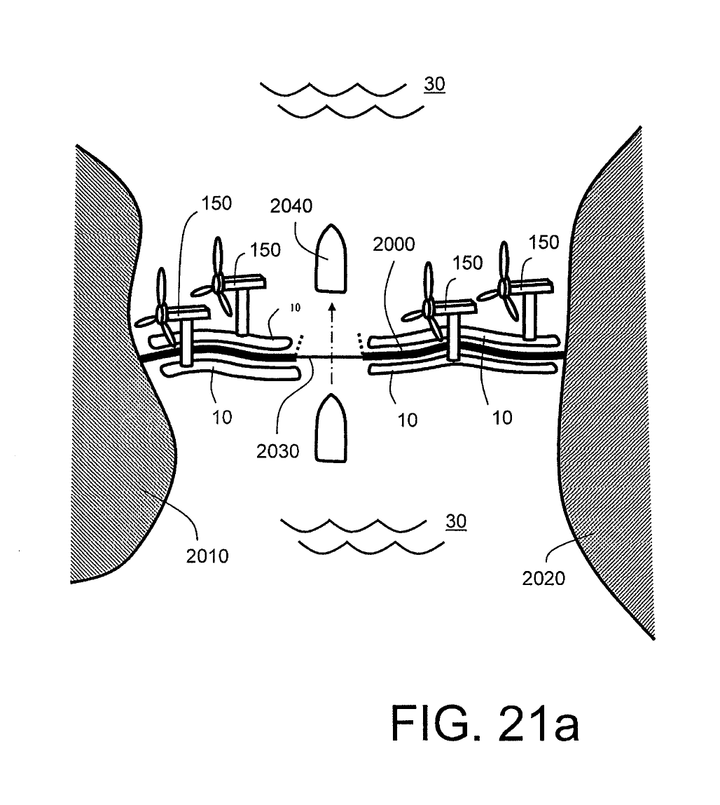

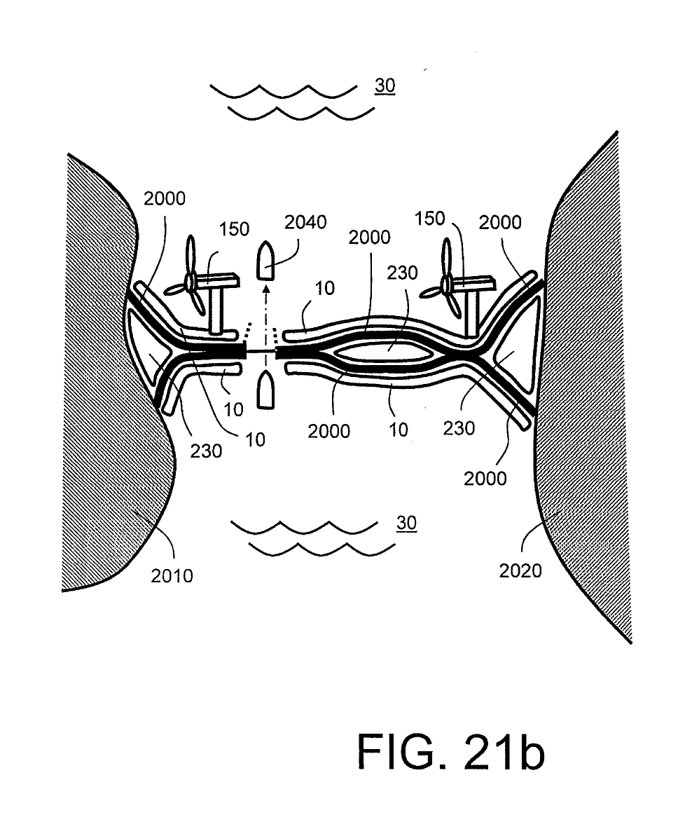

FIG. 21a (FIG. 21a) is a schematic illustration of the ocean wave system of FIG. 1 pursuant to the present invention implemented as an energy bridge structure linking two regions of land, with one or more bridge opening regions for allowing shipping to traverse the bridge structure;

FIG. 21b (FIG. 21b) is a schematic illustration of the ocean wave system of FIG. 1 pursuant to the present invention implemented as an energy bridge structure linking two regions of land wherein transport routes of the bridge define a hoop therebetween for increasing strength of the bridge in respect of tidal flows and other lateral forces experienced by the bridge structure as well as defining an aquaculture region of calm water within the hoop; and

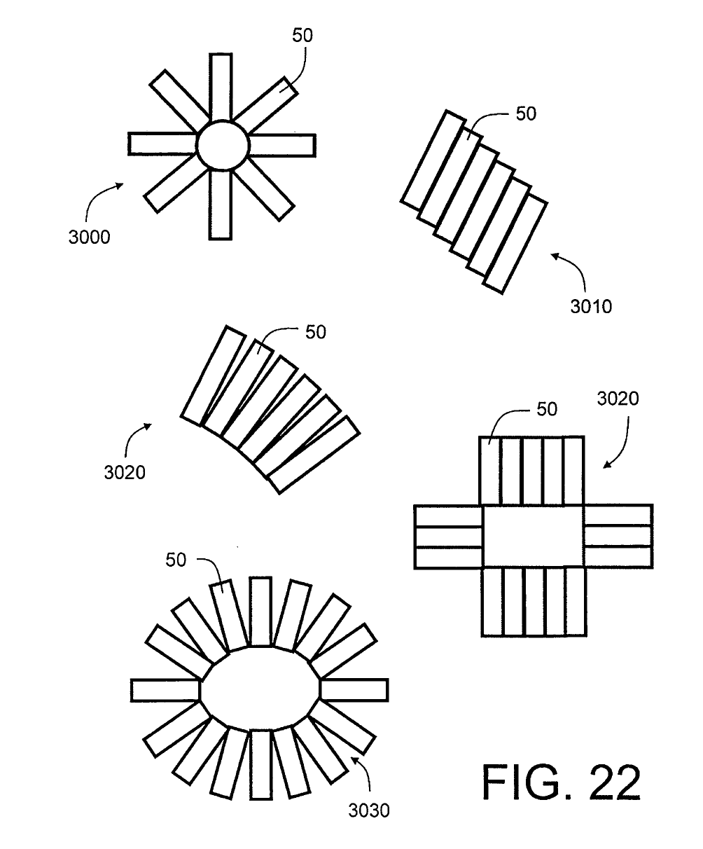

FIG. 22 (FIG. 22) is a schematic illustration of alternative configurations of channels of the ocean wave energy system of FIG. 1.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS OF THE INVENTION

In overview, the present invention concerns an ocean wave energy system as indicated generally by 10 in FIGS. 1a to 5. The system 10 comprises a plurality of substantially mutually parallel planar wall components 20 which are at least partially submerged in an ocean 30 when in use. In operation, ocean waves 40 are guided along elongate channels 50 formed between corresponding adjacent planar wall components 20; namely, the ocean waves 40 are “formed” between the components 20. The channels 50 are each furnished with one or more mutually independently movable floats 100. When a single float is employed, the single float beneficially comprises a plurality of mutually hinged float sections therein, the hinged float sections being of progressively diminishing length. The one or more floats are operable to rise and fall relative to their respective planar wall components 20 in response to ocean waves 40 propagating along the channels 50, the one or more floats 100 thereby generating mechanical energy which is subsequently converted to generate electricity. When a plurality of the floats 100 are included within a channel 50, a largest float 100(1) is beneficially included on a first side 110 of the system 10 facing towards incoming ocean waves 40, and are progressively smaller along the channels 50 towards a second side 120 of the system 10 remote from the incoming ocean waves 40 whereat a smallest float 100(n) is included. Beneficially, the floats 100 have mutually different physical sizes, for example length along the channels 50, so that the floats 100 are operable to efficiently extract energy from waves 40 having a spectrum of spatial wavelengths. Optionally, as illustrated in FIG. 2b, the channels 50 are progressively tapered from the aforementioned first side 110, whereat the channels 50 are widest, to the aforementioned second side 120, whereat the channels 50 are narrowest, thereby providing for concentrating ocean wave energy along the channels 50 for increasing their vertical amplitude.

In contradistinction to the aforementioned Pelamis wave energy system as elucidated in a published PCT patent application no. WO 0017519 A1 and U.S. Pat. No. 6,476,511 which is believed to only extract approximately 10% of available ocean wave energy, the system 10 pursuant to the present invention is susceptible to being implemented such that it absorbs substantially 100% of available wave energy received at the system 10, even in storm conditions. Such advantage is provided by the system 10 on account of its floats 100 being of progressively diminishing size from front to rear of the system 10 for coupling efficiently to a wide range of ocean wave wavelengths, in combination with the planar wall components 20 assisting to spatially form ocean waves so that they synergistically most efficiently couple to the floats 100. In terms of electrical generating capacity of the system 10 relatively to its cost of construction, such an order of magnitude enhanced efficiency of energy extraction from ocean waves, even for relatively low ocean wave amplitudes, provided by the system 10 renders it potentially highly commercially attractive.

When implementing the invention, the planar wall components 20 are optionally implemented to be massive buoyant structures which beneficially each have a length X greater than a longest wavelength Lₘₐₓ of ocean waves 40 which are likely to be encountered by the system 10 when in operation. Moreover, each planar wall component 20 beneficially has a depth Y which is beneficially in a range of 0.1× to 0.6×, for preferably in a range 0.2× to 0.5×. On account of the plurality of planar wall components 20 being so massive, they conveniently form a foundation for off-shore wind turbines 150, 180 such that the ocean wave energy system 10 is thereby capable of both extracting energy from wind motion as well as ocean wave motion. Alternatively, the wind turbines 150, 180 are mounted on substantially horizontal bridging components 160 disposed above the channels 50. The bridging components 160 synergistically also support at least a part of an energy extraction arrangement for converting motion of the floats 100 to electricity.

The wind turbine 150 is beneficially of a design generally akin to that manufactured by Vestas AS (Denmark) and Gamesa SA (Spain), namely comprising a central column, a rotatable nacelle machine house mounted at an upper end of the column, and a rotatable turbine blade arrangement mounted to the machine house. The machine house beneficially houses a variable-ratio gear box and electrical generators for converting mechanical rotation energy of the turbine blade arrangement to electrical energy. The wind turbine 180 is beneficially a vertically-mounted cylindrical wind turbine which is potentially simpler and more robust than the wind turbine 150 but potentially not as efficient as the wind turbine 150 for converting wind energy to electrical energy. Optionally, the wind turbine 180 is of a type devised by the present inventor wherein the turbine 180 includes one or more rotors which are edge supported at location around its periphery and is provided with one or more energy take-off units disposed around the periphery; such a wind turbine construction is highly robust and addresses many problems associated with conventional types of wind turbines conventionally employed in off-shore environments.

Optionally, as illustrated in FIG. 4b, the planar wall components 20 and/or the bridging components 160 are adapted to support one or more solar energy collectors 170, for example:
(a) the one or more solar energy collectors 170 are implemented as one or more passive or actively-steered mirrors for focussing solar energy 185 towards steam-generating ovens 190 for subsequent steam generation for steam-turbine electrical power generation; condensation of the steam to generate fresh water is optionally then used in osmotic power generation apparatus for additionally generating energy from a difference in ionic concentration between the condensate fresh water and saline ocean water by use of a suitable ion exchange membrane; and/or
(b) photovoltaic panels 200 for direct electrical energy generation.

Thus, the system 10 is capable of exhibiting considerable synergy when supporting different types of energy generation when in operation, and not merely limited to electricity generation derived from ocean wave power. Optionally, the steam-generating ovens 190 are synergistically mounted on the cylindrical columns of the wind turbines 150 and the one or more solar energy collectors 170 are disposed substantially around a base of the cylindrical columns.

The planar wall components 20 are beneficially buoyant components whose height and inclination above an ocean surface in an ocean environment are susceptible to being dynamically adjusted in response to prevailing ocean wave conditions; for example, the planar wall components 20 include one or more buoyancy tanks operable to be selectively partially flooded with water which enable the components 20 to be raised and lowered relative to an upper surface of the ocean 30, and the first ends of the planar wall components 20 near the first side 110 can be raised or lowered relative to the second ends of the planar wall components near the second side 120 to control inclinations of the components 20.

In a region of tranquil water at the second side 120 behind the plurality of planar wall components 20, namely remote from where ocean waves 40 impinge upon the plurality of planar wall components 20 at the first side 110, aquaculture 230 is beneficially performed, wherein water motion associated with operation of the system 10 is efficient at removing biological waste products from such aquaculture 230 whilst simultaneously providing a relatively calm environment for fish of the aquaculture 230.

One or more of the planar wall components 20 are optionally provided with submerged features 250 extending further out at the first side 110 for performing wave shaping. Conveniently, the submerged features 250 are extensions of the planar wall components 20 themselves, for example extension lobes of the components 20, or are additional structures such as submerged plates 260 or submerged vanes whose principal planes are optionally orthogonal to whose of the planar wall components 20 as illustrated in FIG. 2b. Such wave shaping includes spatially synchronizing wave crests of the incoming ocean waves 40 so that more efficient energy extraction by way of the floats 100 is feasible; such wave shaping analogously corresponds to steering a polar sensitivity characteristic of a phase array of receivers, for example in multi-antenna microwave radar systems.

Optionally, the ocean wave energy system 10 is also provided with ship docking facilities 270 as illustrated schematically in FIG. 5 so that energy-intensive industries, for example aluminium smelting from bauxite and fertilizer production, can be executed locally at the system 10 so that raw materials and finished products can be conveniently transported to and from the system 10 respectively by ship. Servicing facilities such as cranes and lifting equipment 280 as illustrated in FIG. 4b are optionally mounted on the planar wall components 20, for example for performing maintenance of the system 10, for example repairing and/or manipulating the floats 100.

Additionally, the system 10 optionally includes a residential region for personnel, as well as well as optionally a harbour for yachts and small sailing vessels. The system 10 can even include an artificial beach, a tax-free shopping centre, a casino, health centres, massage parlours and pedicure centres for tourists coming to visit the system 10 to admire its creation. Yet additional, one or more of the planar wall components 20 are optionally furnished with a helipad at which helicopters are able to land and alight.

The planar wall components 20 are beneficially susceptible to being decoupled from their one or more neighbouring planar wall components 20, for example for replacement or repair, or for adding one or more additional planar wall components 20 for enlarging the system 10. In operation, the system 10 can be anchored to a floor of the ocean 30, for example by way of anchors linked to tethering chains coupled to the system 10. Alternatively, the system 10 can be maintained actively in position using GPS position and magnetic compass orientation references in combination with driven thruster propellers to correct for any spatial drift of the system 10 within the ocean 30. The system 10 is potentially of a large size; for example, the planar wall components 20 beneficially each have a width Z in a range of 1 metre to 50 metres, a length X in a range of 5 to 1000 metres in a direction along the channels 50, and a height Y in a range of 3 metres to 50 metres high in a substantially vertical direction. In a range of two to several thousand of the planar wall components 20 are susceptible to being mounted together so as to provide the system 10 with an overall length orthogonal to the channels 50 of potentially up to kilometres, for example to construct energy bridges or energy peninsula between one or more land regions; in view of ocean wave energy being estimated to have a density of circa 70 kW/metre on average, the system 10 built to have a length of 10 km could potentially produce from wave energy in an order of at least 400 MW power accounting for losses in converting ocean wave energy to electrical energy. Such a power output is comparable to a large conventional nuclear power station or coal-fired power station. In comparison, the four nuclear fission reactors at Chernobyl had a combined output of 4 GW before the tragic Chernobyl nuclear accident occurred. If the system 10 were deployed along a whole length of the Norwegian coast, an electrical power output of approaching 50 GW would be reasonably feasible, namely more than enough to comfortably meet Europe's present electrical energy needs. The system 10 could not result in any form of nuclear fission explosion on account of it being non-nuclear in nature. Any accident in the system 10 is likely to be highly localized and unlikely to give rise to highly toxic and dangerous contamination. Environmental consequences of the Chernobyl nuclear accident have been tragic.

In order to further elucidate the present invention, some basic principles regarding ocean wave energy and ocean wave propagation characteristics will now be described. When an ocean wave 40 propagates, it corresponds to an energy flow; substantially circular cyclical water movement as denoted by 300 occurs as energy embodied in the ocean wave 40 propagates as illustrated in FIG. 6. A propagation direction of the wave 40 is denoted by an arrow 310. The wave 40 has a spatial wavelength of L and a trough-to-peak amplitude of H. When the wave 40 propagates with a velocity c, a frequency f of the wave 40 is defined by Equation 1 (Eq. 1):

f=c/L Eq. 1

On account of oceans of Earth not having any preferred frequency for ocean wave propagation, namely no preferred resonant frequency characteristic, ocean waves are susceptible to occurring over a wide range of frequencies f and amplitudes H. Moreover, on account of wave generation phenomena occurring simultaneously at various spatial locations, ocean wave motion is a superposition of many sinusoidal wave groups. A phenomenon of waves breaking on a beach is non-representative of a complex superposition of various waves groups as observed off-shore in deep waters.

Ocean waves which are generated by wind interactions with an ocean surface are known as “wind waves”. When these wind waves have propagated from a spatial region in which they were created, they are then known as “swells”. These swells exhibit a characteristic in that they are capable of propagating relatively large distances, for example across the Pacific Ocean with relatively little energy loss, almost in a manner akin to a soliton wave. A reason for such little loss is that ocean swell waves are essentially surface waves in a relatively incompressible viscous medium of ocean water. Circular water motion associated with a propagating ocean wave reduces substantially exponentially with depth D as illustrated in FIG. 7; for example, at a depth of D=L, most of circular water motion associated with a surface ocean wave is diminished. On account of such a diminishing characteristic with depth D, submarines travelling submerged are often unaffected by severe storms raging at an ocean surface above them. In a similar manner, the planar wall components 20 of the system 10 are susceptible to being lowered in the ocean 30 in extremely severe storm conditions to assist to protect the system 10. Such lowering of the components 20 is susceptible to being achieved by at least partially filling their buoyancy tanks with water; conversely, the components 20 are susceptible to being raised in the ocean 30 by pumping water from their buoyancy tanks. When the planar wall components 20 have a height Y considerably greater than the longest ocean wave wavelength Lₘₐₓ, the components 20 are thereby beneficially stabilized in severe weather conditions. Most hitherto known ocean wave energy systems have simply been constructed in relatively too small dimensions to make them sufficiently robust against severe storm conditions; however, the present invention also synergistically is more robust on account of its form of construction and shape as will be elucidated in more detail later.

Energy content of ocean waves is calculable from Equation 2 (Eq. 2):

E=k_{E}H² Eq. 2

wherein
E=ocean wave energy content;
k_{E}=a constant equal to ρg, wherein ρ is a density of salty ocean water of 1020 kg/m³, and g is a gravitational constant of 9.8 m/s²; and
H=ocean wave vertical amplitude as defined earlier with reference FIG. 6.

For example, an ocean wave having an amplitude H=2 metres has an energy content of 5 kJ/m². A rate of energy transport J in ocean waves is calculable then from Equation 3 (Eq. 3):

J=c_{g}E Eq. 3

wherein
c_{g}=group velocity calculable from c_{g}=gT/4π wherein T=L/c for deep ocean water;
E=ocean wave energy content as calculable from Equation 2 (Eq. 2); and
J=energy flow;
wherefrom Equation 3 (Eq. 3) is susceptible to being re-expressed as Equation 4 (Eq. 4):

J=k_{f}TH² Eq. 4

wherein
k_{f}=ρg², namely approximately 1 kW/m³s

For example, an ocean wave 40 exhibiting a period T=10 seconds and an amplitude of 2 m has associated therewith an energy flow of 40 kW/m which represents considerable power.

In practice, ocean waves are a complex superposition of a plurality of propagating individual waves. Such superposition seems poorly appreciated in earlier patent literature concerning ocean wave energy systems. The plurality of propagating individual waves are susceptible to having a spectrum of wavelengths L and heights H; in practice, the wavelengths are mostly included in a range of Lₘᵢₙ to Lₘₐₓ, and the height H is included in a range of 0 metres to Hₘₐₓ. In consequence, movement of an ocean surface at a given spatial position can often be found to vary considerably such that the height H can superficially to an observer appear highly variable as a function of time t., namely in a seemingly random manner. If an ocean wave spectrum is represented by a function S(f), an effective wave height as observed by an observer at a given position in an ocean is given by Equation 5 (Eq. 5):

$$E = ρ g {\int }_{0}^{∞} S ( f ) d f = \frac{ρ {gH}_{g}^{2}}{16} \qquad Eq . 5$$

wherein
H_{g}=group wave height

Although Equation 4 (Eq. 4) describes a theoretical expected ocean wave energy transport J, an energy transport rate observed in practice is approximately half this value when spectral superposition of many ocean waves of diverse spectral characteristics are taken into consideration.

When measurements are made regarding ocean wave spectra, a characteristic graph as illustrated in FIG. 8a is observed for windy ocean weather. The graph of FIG. 8a includes an abscissa axis 330 corresponding to wave frequency, and an ordinate axis 340 describing a corresponding function in Equation 5 (Eq. 5). Moreover, the graph of FIG. 8a illustrates a lower wave frequency of 0.05 Hz and an upper wave frequency of substantially 0.25 Hz. Furthermore, the graph of FIG. 8a includes a maximum peak 350 at a frequency of 0.08 Hz corresponding to swells with a tail characteristic 360 substantially between 0.1 Hz and 0.2 Hz. For most efficiently collecting ocean wave energy, the ocean wave energy system 10 is required to be responsive in a frequency range including substantially two octaves. Contemporary ocean wave energy systems do not have a response characteristic which can efficiently cope with such a large wave frequency range.

In FIG. 8b, there is shown a graph regarding ocean wave spectra for a mixture of windy sea and swells. In the graph of FIG. 8b, there is an abscissa axis 370 corresponding to wave frequency f, and an ordinate axis 380 representing the aforementioned function S(f) of Equation 5 (Eq. 5). There is a lower wave frequency of 0.05 Hz and a maximum upper wave frequency of substantially 0.35 Hz. There are shown two distinct peaks, namely a first peak 390 centred around 0.08 Hz corresponding to swells, and a second peak 400 centred around 0.19 Hz corresponding to wind-excited waves. FIG. 8b corresponds to an ocean wave frequency range of substantially two octaves, namely nearly an order of magnitude. Although most energy is conveyed by way of swells, FIG. 8b illustrates that very significant energy is included at higher frequencies in the form of wind-induced waves.

The inventor of the present invention has appreciated that ocean wave energy must be extracted at all wave frequencies if an energy yield from the system 10 is be optimized relative to a cost of constructing and operating the system 10. As elucidated in the foregoing, efficiency of operation of the system 10 is important, especially when the system 10 is to commercially compete against alternative sources of energy, for example fossil fuel burning electricity power stations and nuclear power stations.

Fundamental principles of ocean wave energy propagation have been elucidated in the foregoing. The ocean wave energy system 10 will now be described in greater detail. Referring to FIG. 9, an example of one of the planar wall components 20 is shown in side view and comprises a main section 500 having a substantially straight top surface 510, a tapered bottom surface 520 which tapers from the first side 110 towards the second side 120, the feature 250 implemented as a submerged projection from the main section 500. The tapered bottom surface 520 can commence at an end 530a of the main section 500, or commence at a mid-point 530b along the main section 500; moreover, the tapered bottom surface 520 has an angle η which is optionally in a range of 2° to 60°, and more optionally is in a range of 10° to 30°. Optionally, the tapered bottom surface 520 develops smoothly from the main section 500 as a curved profile such the mid-point 530a, 530b is a part of a generally curved profile 535. The main section 500 includes a plurality of buoyancy tanks 540 which are selectively at least partially filled with air or sea water in order to control a height of the planar wall component 20 relative to a surface 550 of the ocean 30, and also control an inclination angle θ of the planar wall component 20 in the ocean 30; the inclination angle θ is optionally in a range of −30° to +30°, more optionally in a range of −15° to +15°. The feature 250 is of benefit in that it creates a mild drag on ocean waves 40 propagating in operation towards the first side 110 of the system 10; such drag is potentially dynamically variable by raising or lowering the feature 250 relative to the surface 550 and/or by changing a form of the feature 250 which causes several effects:
(a) ocean waves 40 are encouraged to break, thereby causing their amplitude H to locally increase in the channels 50;
(b) ocean waves 40 at various spectral frequencies become more phase aligned at an entrance to the channels 50 so that wave energy in the ocean waves 40 is more efficiently extracted by the floats 100 within the channels 50; and
(c) wave crests approaching each of the channels 50 are more spatially synchronized to a common wave front so that floats 100 of a given size along the channels 50 move up and down in temporal synchronism which potentially renders energy extraction in certain circumstances more efficient, depending upon type of energy extraction arrangement utilized within the system 10.

The length X is beneficially in a range of 5 to 200 metres long, more preferably in a range of 5 to 1000 metres long, and most preferably in a range of 10 to 100 metres long. The height Y is preferably in a range of 2 to 50 metres, more preferably in a range of 5 to 30 metres, and most preferably in a range of 10 to 30 metres.

As elucidated in the foregoing, the floats 100 are optionally progressively of diminishing length and width along the channels 50 from the first side 110 to the second side 120 as the channels 50 are beneficially tapered. Such a spatially progressively diminishing size arrangement for the floats 100 is of importance because energy is progressively extracted from the impinging ocean waves 40 along the channels 50 from the first side 110 to the second side 120 so that energy is firstly extracted from relatively longer wavelength wave components by the floats 100(1) and so forth and finally extracted from relatively shorter wavelength wave components by the floats approaching 100(n) near the second side 120. In such a manner, impinging ocean waves 40 at the first side 110 are not reflected back to the ocean 30, nor are they able to propagate to the second side 120, namely their complete energy is substantially extracted along the channels 50 by the system 10. Such performance is to be juxtaposed with known ocean wave energy systems which seemingly extract available wave energy but in reality reflect a considerable portion of incoming wave energy back into the ocean 30. Such enhanced efficiency of wave energy extraction provided by the present invention is of considerable performance and economic benefit, namely substantial wave reflection does not occur which clearly distinguishes the present invention from earlier known ocean wave systems.

The floats 100(1) at an entrance of the channels 50 are largest and are optimized for ocean wave energy extraction of a longest ocean wave wavelength Lₘₐₓ likely to be received at the first side 110 of the system 10; for example, the float 100(1) has a length along the channel 50 in a range of 3 metres to 15 metres, more preferable in a range of 5 metres to 12 metres, namely corresponding to approximately Lₘₐₓ/2. Moreover, the floats 100(n) at an exit of the channels 50 are smallest and are optimized to extract ocean wave energy corresponding to a shortest ocean wave wavelength Lₘᵢₙ likely to impinge at the first side 110 of the system 10; for example, the float 100(n) has a length along the channel 50 in a range of 0.5 metres to 3 metres, for preferably in a range of 0.8 metres to 2 metres, namely corresponding to approximately Lₘᵢₙ/2. Optionally, as shown in plan view in FIG. 10, the channels 50 are tapered to have a width W1 at the first side and a width. W2 at the second side 120. Preferably, tapering along the channels 50 is uniform as illustrated. Alternatively, tapering along the channels 50 is non-uniform, for example following a curved or exponential taper. A ratio W1/W2 is preferable in a range 1 to 10, more preferable in a range 1 to 5, and most preferably in a range 1 to 3. Moreover, the floats 100 are preferably formed in a tapered manner to at least partially match a form of taper provided along the channels 50 as illustrated in FIG. 10.

In operation, the floats 100 are buoyant at the surface 550 of the ocean 30 and move up and down in response to ocean waves 40 being guided and subsequently propagating along the channels 50. Energy is progressively extracted from the ocean waves 40 as illustrated, for example, in FIG. 11 in relation to FIG. 8b wherein:
(a) a float 100(1) extracts most wave energy associated with the peak 390 in a wave frequency range of 0.05 Hz to 0.1 Hz;
(b) a float 100(2) extracts most wave energy associated with a residual wave energy from the peak 390 in a wave frequency range of 0.1 Hz to 1.5 Hz;
(c) a float 100(3) extracts a considerable portion of wave energy associated with the peak 400 in a frequency range of 0.15 Hz to 0.2 Hz; and
(d) a float 100(4) extracts substantially a remaining portion of wave energy associated with the peak 400 is a frequency range of 0.2 Hz to 0.26 Hz.

It will be appreciated that although FIG. 11 illustrates the channels 50 including four floats 100(1) to 100(4), other numbers of floats 100 are susceptible to being employed. For example, more than four floats 100 can be employed to ensure that there is even less residual wave energy transmitted from the first side 110 via the channels 50 with their floats 100 to the second side 120. Alternatively, in order to obtain a simpler configuration, less than four floats 100 are employed for each channel 50. In a simplest implementation, there is just a single float 100 included in each of the channels 50; in such a simple implementation, the single float 100 is beneficially implemented to comprise multiple sub-floats joined together in a hinged manner as illustrated on FIG. 12; the single float 100 including multiple sub-floats beneficially has a largest sub-float near the first side 110 and a smallest sub-float near the second side 120; alternatively, the sub-floats are all of a substantially same smaller size so that several small sub-floats in combination cooperate to extract energy from relatively longer wavelength ocean waves 40 propagating within the channels 50. Optionally, the channels 50 of the system 10 are equipped with mutually different float 100 arrangements; for example in response to a position of a given channel 50 within the system 10, for example whether central channels 50 in the system 10 or outmost channels 50.

The floats 100 are required to move up and down; as denoted by an arrow 600 in FIG. 13a, within the channels 50 in diverse weather conditions, preferably without the floats 100 rubbing against sides of the channels 50 defined by the planar wall components 20. Preferably, the floats 100 are maintained in position between its planar wall components 20 by one or more tetherings 610; for example, the one or more tetherings 610 include one or more of chains, ropes, cords, belts, bands, rods, levers. Optionally, the one or more tetherings 610 are elastically compliant, for example including spiral springs therealong which are operable to undergo strain when subjected to stress. Optionally, the one or more tetherings 610 are dynamically shortened and lengthened by sensing a position of the float 100 and offering lengths of the one or more tetherings 610 to maintain the float 100 within a preferred up and down trajectory within its channel 50, for example by using actively driven winches.

In FIG. 13a, a width of the channel is denoted by W_{K} and a width of the float 100 is denoted by W_{F}. A ratio W_{F}/W_{K} is preferably in a range 30% to 99%, more preferably in a range 40% to 80% so that a portion of ocean wave energy is permitted to leak past relatively bigger floats to reach relatively smaller floats, and most preferably in a range of 50% to 70% to allow space for the one or more tetherings 610. Optionally, at least a part of the float 100 in FIG. 13a is susceptible to being implemented as two parallel floats 100a, 100b which are hinged together in a direction along the channel 50 as illustrated in FIG. 13b which assists the tethering 610 to function effectively. The float 100 is even susceptible to being implemented in three parts as illustrated in FIG. 13c which provides a benefit that it is well centred by the tetherings 610 within its channel 50 and yet is highly able to conform to a surface profile of ocean waves 40 propagating along the channel 50.

As elucidated in the foregoing, a combination of the planar wall components 20 defining channels 50 in which a series of floats 100 progressively absorbs wave energy over a spectrum of wave frequencies to which the floats 100 are specifically adapted is a central concept in the present invention. Of considerable importance is an efficiency of energy recovery from the floats 100. Early ocean wave energy systems employed pumped hydraulic arrangements for conveying energy from floats to an electrical generator in a somewhat energy inefficient manner. In view of the system 10 being required to commercially compete with other sources of electrical energy, for example fossil fuel burning installations, it is desirable that the system 10 be as energy efficient as possible. The inventor has appreciated that simple mechanical arrangements are capable of being very energy efficient, inexpensive and robust.

Referring to FIG. 14, there is shown a first arrangement for converting motions of the floats 100 disposed along the channel 50 into electricity. The arrangement includes flexible couplings 650 implemented as flexible bands, belts, chains or similar; the couplings 650 are coupled to sides of the float 100 as illustrated and guided one or more times around pulleys 670. The pulleys 670 are rotationally mounted via corresponding supports 660 to sides of the planar wall components 20 as illustrated. One or more of the pulleys 670 are coupled to alternating current (AC) generators 680 whose electrical outputs are rectified in a rectifier unit 690 and then transformed via a electronic pulse-width-modulated (PWM) power converter 700 to provide power to be fed to an electricity network, for example via an underwater cable (not shown).

The arrangement shown in FIG. 14 is of advantage in that it is susceptible to being implemented to provide a very efficient coupling of motion energy of the float 100 to electrical energy, for example even as high as 80% to 90% efficient. However, the arrangement has numerous moving parts which are directly exposed to the ocean 30 and therefore potentially needing regular maintenance and replacement. The couplings 650 when implemented as bands are preferably stainless steel components or reinforced rubberized components which are relatively resistant to corrosive ocean salts. Beneficially, the arrangement of FIG. 14 provides a major advantage that the float 100 can selectively have its one or more buoyancy tanks selectively at least partially filled with water to sink the float 100 below the surface 550 of the ocean 30 in the channel 50, for example to protect the float 100 in severe storm conditions or to disable an effect of the float 100 when adjusting the system 10 for optimal performance as described in more detail below.

An alternative arrangement for generating electrical energy from movements of the floats 100 is illustrated in FIG. 15a based upon use of a siphon principle. In this arrangement, each float 100 is furnished with an siphon duct 730 fluidly coupling water present in a first tank 770 included in the planar wall component 20 adjacent to the float 100 to a tank 780 included in the float 100. When the float 100 moves up and down, as denoted by an arrow 600, in response to ocean waves 40 propagating along the channel 50, water is transferred back and forth between the tanks 770, 780 as denoted by an arrow 740. The duct 730 includes a lower-pressure large-diameter water turbine 750 which is coupled via a transmission shaft 760 to the aforesaid alternating current (AC) generator 680 whose electrical output is rectified in a rectifier unit 690 and then transformed via a electronic pulse-width-modulated (PWM) power converter 700 to provide power to be fed to an electricity network, for example via an underwater cable (not shown). The arrangement of FIG. 15a is provided with water pumps 790, 800 for filling or emptying the tanks 770, 780 respectively, and also with an air pump 810 for sucking or admitting air into the siphon duct 730 for establishing or disabling the siphon. Although water is a preferred liquid to employ in the tanks 770, 780, other types of fluids can be alternatively employed to obtain desirable fluid flow within the duct 730, for example low-viscosity light oils.

The arrangement shown in FIG. 15a has many significant advantages associated therewith which will now be elucidated. Beneficially, the arrangement only has two moving parts, namely the turbine 750 and the float 100. The pumps 790, 800, 810 are only required to operate intermittently to adjust an amount of water in the siphon and to re-establish the siphon. Moreover, the duct 730 is beneficially fabricated to have a wide diameter to offer as low a flow resistance as possible, thereby improving energy efficiency. Moreover, the end of the duct 730 within the water of the tank 780 provides the float 100 with freedom to tilt, move up and down, move backwards and forward without a need to provide any form of seal which is susceptible to perishing or work-harden after repeated cycles of operation; such a feature is of great benefit in respect of long-term reliability of operation of the arrangement of FIG. 15a. The duct 730 is beneficially attached to its associate planar wall component 20. Beneficially, the duct 730 forms a part of the bridging component 160 as illustrated in FIGS. 4a, 4b so that synergistically the floats 100 are protected from damage caused by severe ocean waves, the bridging components forming foundations for wind turbines 150 and/or solar collectors and/or solar panels as elucidated in the foregoing. Many synergistic benefits derive from the arrangement of FIG. 15a which has a potential to become an optimal standard approach for extracting energy in ocean wave energy systems employing floats.

The arrangement of FIG. 15a is of further benefit in that the float 100 beneficially has two buoyancy tanks 830 as illustrated in FIG. 15b. These tanks 830 are of benefit in that the pump 800 is operable to selectively at least partially fill the buoyancy tanks 830 as well as the tank 780 to enable the float 100 to be optionally submerged for protection or for removing its effect in the channel 50 is certain ocean wave conditions as will be elucidated later.

Although FIGS. 14, 15a and 15b illustrate advantageous arrangements for extracting motional energy from the floats 100 along the channels 50, other arrangements are possible. For example, a simple lever arrangement for extracting motional energy from the float 100 is illustrated in FIG. 16 wherein the float 100 is coupled to a substantially vertical member 900. The vertical member 900 is, in turn, coupled via a rotational pivot 910 to a first end of a substantially horizontal member 920 which itself is supported substantially midway therealong on a pivot 930. A second end of the substantially horizontal member 920 includes a curved toothed member which acts upon a toothed shaft of the alternating current (AS) electricity generator 680 which is operable to provide an electrical output which is rectified in the rectifier unit 690 and then conditioned in the PWM converter unit 700 for feeding onto an electricity network (not shown).

Referring next to FIG. 15c, a particular implementation of the arrangements of FIG. 15a, 15b is schematically illustrated in a transverse direction relative to a direction along the channels 50. A bridging component 160 is employed to support and house the siphon duct 730, for example to protect it from damage in storm conditions. The generator 680 together with its rectifier unit 690 and its PWM converter unit 700 are protected within a housing 840 mounted to the bridging member 160 or directly onto the planar wall component 20. The pump 810 for establishing a siphon in the duct 730 is beneficially also included within the housing 840. Beneficially, a wind turbine 150 is mounted upon the housing 840; alternatively, the housing 840 is an integral part of a cylindrical column of the wind turbine 150. An upper planar portion of the bridging member 160 is beneficially employed to support solar collectors, for example rows of solid-state thin-film solar cells for direct electricity generation from sunlight. The bridging component 160 is firmly located to its associated planar wall component 20a and also flexibly attached to its neighbouring planar wall component 20b. Submerged transverse members 1870 as will be elucidated later are beneficially included beneath the channels 50 for assisting to mechanically stabilize the system 10 and maintain the planar wall members 20 in desired spatial separation. The arrangement illustrated in FIG. 15c is particularly practical and synergistically advantageous. The arrangement illustrated schematically in FIG. 15c is susceptible to being further modified such that the water turbine 750 is designed so that it rotates in a same direction, irrespective of a direction of water flow therethrough. Yet alternatively, there are provided two ducts 730 between the tanks 770, 780 with flap valves or similar types of one-way valves so as to ensure water flows uni-directionally in the two ducts 730 so that their respective turbines 750 to rotate only in one rotation direction. Such uni-directional flow is beneficial when each turbine 750 is coupled via a gearbox to an electrical generator such that rotational direction reversal is detrimental with regard to wear to such a gearbox. Optionally, when two ducts 730 employed, they are mutually joined together along at least a part of their length. Yet alternatively, a single duct 730 is employed in conjunction with a single turbine 750 and there is further included moveable fluid flaps or fluid guides for ensuring that water flow occurring along the duct 730 is guided in such a manner that the turbine 750 is only caused to rotate in one direction. Optionally, the fluid flaps or fluid guides are operated by way of pressure differences arising in response to movement of the float 100. Alternatively, movement of the float 100 can be monitored by one or more sensors generating signals indicative of the float 100, and such fluid flaps or fluid guides actuated in response to the one or more sensor signals so that the turbine 750 is maintained rotating in a constant direction; optionally, the fluid flaps or fluid guides are computer controlled wherein the computer is provided with the one or more signals are input data.

The arrangement illustrated in FIG. 16 is of benefit in that it is capable of being easy to maintain and service. Moreover, it is capable of transferring motional energy of the float 100 into mechanical force to drive the generator 680 with a relatively small loss of energy. Furthermore, when the members 900, 920 are implemented as massive components, they are robust to damage, for example to ocean storm conditions. As described earlier, the arrangement of FIG. 16 enables buoyancy tanks of the float 100 to be filled with water to submerge the float 100 within the channel 50 when required to protect the float 100 from damage in severe storm conditions or for more efficiently coupling wave energy to relatively smaller floats 100 further along the channel 50 in conditions of relative calm in the ocean 30. Such operation will be described later in more detail.

In FIG. 17, a further arrangement for converting motion energy of the float 100 in response to ocean waves 40 acting thereupon to electricity is illustrated. The float 100 is coupled via a flexible coupling 1000 which acts directly on a shaft of the alternating current generator 680. The flexible coupling is terminated at a first end of an elongate counterweight 1010. The counterweight 1010 is pivotally mounted via a pivot 1020 at its second end as illustrated to the planar wall component 20 or to its bridging component 160. The flexible coupling 1000 is beneficially implemented as a chain, a metal band, a rubberized band or similar; for example, the band 1000 is beneficially fabricated from stainless steel parts. In operation, when the float 100 moves up and down within the channel 50 as denoted by the arrow 600, the coupling 1000 causes the counterweight 1010 to move up and down in synchronism, thereby causing the coupling 1000 to turn the shaft of the generator 680 and thereby generate electrical power which is rectified in the rectifier unit 690 and then conditioned by the PWM converter unit 700 to feed onto an electricity network (not shown), for example an underwater electrical cable coupling the system 10 electrically to land. The arrangement illustrated in FIG. 17 is of benefit in that it has few moving parts, is easy to access for servicing purposes, and is also capable of efficiently transferring motion energy of the float 100 to electrical energy. By filling buoyancy tanks of the float 100 and allowing the counterweight 1010 to be lifted up, the float 100 is able to be submerged for protecting it from severe storm conditions or removing its effect when smaller floats further along the channel 50 are to have unhindered exposure to incoming ocean waves 40 as will be elucidated further later.

Yet simpler arrangements are feasible for extracting motional energy of the floats 100 to generate electrical power. For example, a simple arrangement is illustrated in FIG. 18a wherein the float 100 is provided with two substantially vertical magnet-bearing members 1120 each coupled via a flexible substantially horizontal member 1110 coupling to the float 100 as shown. The magnetic-bearing members are provide with a series of powerful rare-earth permanent magnets whose magnetic field is coupled in operation to coil assembly 1130 mounted on side of the planar sidewall components 20. Optionally, the magnetic-bearing members 1120 have guides to guide their motion in close proximity of the coil assemblies 1130 to ensure efficient coupling of magnetic fields therebetween, for example using compliantly-mounted wheels or rollers so that the magnetic-bearing members do not become jammed against the adjacent planar wall members 20. Yet alternatively, the coil assembly 1130 is beneficially disposed in a submerged manner beneath the float 100, for example in a manner of transverse member linking adjacent planar wall members 20 together, and the magnet bearing members 1120 is mounted to an underside region of the float 100. In operation the magnetic bearing members 1120 are closely magnetically coupled to the coil assembly 1130, for example by way of intermeshed projecting elements as illustrated bearing the magnets and coils which have sufficient clearance to allow for water flow and rocking and lateral displacement of the float 100 when moving in operation. By mounting the coil assembly 1130 and magnet bearing members 1120 under water, they are potentially better protected from damage during storm conditions, for example from damaging storm ocean waves impacting thereonto. Optionally, positions of the coils and magnets are swapped. Yet more optionally, both the coil assembly 1130 and the magnet bearings members 1120 each include a mixture of both magnets and coils.

In operation, the float 100 moves up and down within the channel 50 in response to ocean waves 40 guided along the channel 50 acting upon the float 100. As the float 100 moves up and down, as represented by the arrow 600, the magnet-bearing members 1120 are moved relative to the coil assemblies 1130, thereby generating signals within the coil assemblies 1130 which are subsequently rectified by the rectifier unit 690 and then conditioning in the PWM converter unit 700 for feeding electrical power onto an electrical network (not shown). The advantage with the arrangement of FIG. 18 is that there are very few moving parts required, although energy transfer efficiency of this arrangement is potentially inferior to those illustrated in FIGS. 14 to 17. Beneficially, the magnet-bearing members 1120 and the coil assemblies 1130 are implemented in a manner akin to a linear combustion engine with electrical output, for example as proposed in published patent specifications by Volvo Technology Corporation AB and ABB AB companies in Sweden.

In FIGS. 14 to 18, various configurations for extracting motional energy of the floats 100 are described. These configurations merely serve as particularly advantageous arrangements, although other energy transfer arrangements are susceptible to being employed for implementing the present invention. Several different types of energy transfer arrangements are optionally employed for the system 10, for example as a function of size and/or weight of the floats 100 and their position within the system 10.

Beneficially, operation of the system 10 is automatically controlled using computing hardware operable to execute one or more software products stored on one or more machine-readable data carriers. The system 10 therefore includes computing hardware therein. Achieving maximum energy production from the system 10 is a function of several factors as follows:
(a) a spectrum and amplitude of ocean waves 40 propagating into the channels 50 of the system 10;
(b) adjustment of the features 250, 260 included at a front of the system 10 for steering a preferred receiving angle of the system 10 in respect of incoming waves in a manner analogous to steering polar sensitivity characteristics of a phased-array comprising a plurality of radar antennae;
(c) a height of the planar wall components 20 relative to the ocean surface 550;
(d) an inclination angle of the planar wall components 20 relative to the first side 110 and the second side 120;
(e) a number and configuration of floats 100 deployed within each channel 50;
(f) a height of the floats 100 within the channels 50 relative to their respective planar wall components 20.

Optimization of operation of the system 10 is therefore not a simple task and requires a certain degree of strategy for obtaining maximum electrical output for given ocean 30 conditions. The system 10 is therefore advantageous provided with sophisticated computer control and management system, for example in a manner of a proprietary ERA system developed by Epsis AS, Bergen, Norway.

In FIG. 19, there is shown a flow chart of steps of a method for controlling operation of the system 10. Steps of the method are defined in Table 1.

TABLE 1
Method of controlling the system 10

| Step | Action associated with step |
|---|---|
| 1500 | Sense ocean wave amplitude H and wavelength L, for example by optical |
| | interrogation of the ocean 30 in front of the system 10 or from present power |
| | output generated by the floats 100 |
| 1510 | Compute a frequency spectrum of the ocean waves 40 being received at the |
| | system 10; divide the frequency spectrum into frequency bands corresponding to |
| | preferred response frequencies of different sizes of floats 100, S(f) |
| 1520 | Check whether or not the total ocean wave energy S(f) exceed a safe |
| | operating limit Pₘₐₓ for the system 10? [Y = yes; N = no) |
| 1530 | Submerge one or more of the floats 100; prepare system 10 for surviving |
| | severe storm conditions |
| 1540 | Check whether or not the frequency spectrum energy S(f)ᵢ for a band i is |
| | greater than a threshold for deployment Tᵢ for band i ? [Y = yes; N = no] |
| | starting with i = 1 |
| 1550 | Deploy one or more of the floats 100 corresponding to frequency spectrum |
| | band i, for example by pumping water out of buoyancy tanks of the floats |
| | 100 to raise the floats 100 above the ocean surface 550 |
| 1560 | Retract the one or more floats 100 corresponding to frequency spectrum |
| | band i, for example by pumping water into buoyancy tanks of the floats |
| | 100 to submerge the floats 100 below the ocean surface 550 |
| 1570 | i = i + 1 |
| 1580 | Check whether or not i is greater than k, where k is the total number of |
| | ocean wave frequency bands accommodated by the system 10 ? [Y = |
| | yes, N = no] |

It will be appreciated that the flow chart in FIG. 19 represents one amongst several potential methods for controlling operation of the system 10 and is included merely by way of example. In a steady-state operating condition, the computing hardware represented by 1600 in FIG. 4a, is operable to make small iterations in the deployment of the floats 100, for example raising or lowering their heights relative to the surface 550, adjusting inclination angles of the floats 100 relative to the surface 550, as well as adjusting a height and/or inclination angle of the planar wall components 20 in order to try to optimize power generation within the system 10. It will be appreciated that such adjustment corresponds to iterative optimization of a multivariate system which is a mathematical problem encountered in other branches of technology. However, optimization of the system 10 employs approaches which are different to a classic multivariate optimization problem. For example, the ocean 30 represents a noisy input source to the system 10 whose characteristics are constantly changing. Moreover, in view of time duration involved with raising and lowering the floats 100, there is insufficient time to try all possible iterations in order to find an optimum combination corresponding to optimal adjustment of the system 10. However, each channel 50 of the system 10 is substantially isolated from channels 50 neighbouring thereto so that each channel 50 is susceptible to being individually adjusted in an iterative search of an optimal configuration of floats 100 to employ for any given ocean 30 wave conditions. When there are potentially several hundred channels 50 present in the system 10, it is possible to quickly iterate to an optimum float configuration by considering power output of each individual channel 50 in response to adjustment of its floats 100. Such possibilities do not exist in other classical multivariate system optimization situations.

Thus, after floats 100 have been deployed in the channels 50 pursuant to the steps of the method depicted in FIG. 19, the computing hardware 1600 is operable to iterate deployment of the floats 100 to find an optimum power generation performance by trying different adjustments of the floats 100 for each of the channels 50 so as to test out possibilities temporally in parallel, monitoring power output from each channel 50 individually. By such a parallel approach, the system 10 is rapidly adjusted to be performing optimally in response to ocean 30 wave conditions.

As elucidated in a patent application from which priority is herewith claimed, the inventor has appreciated various details of the present invention which will now be elucidated for completeness.

The planar wall components 20 beneficially have a depth of at least half a maximum wavelength L of waves to be encountered by the system 10, at least when the system 10 is in operation. Moreover, the planar wall components 20 beneficially have a height above the ocean surface 550 which is at least half a peak-to-trough amplitude of a largest wave to be accommodated by the system 10, namely Hₘₐₓ/2. The planar wall components 20 may be constructed from mutually different materials. Moreover, the planar wall components 20 may be deployed as primary, secondary and tertiary wave-forming stages with associated floats 100 in a direction along the channels 50. Support elements for maintaining the planar wall components 20 spaced apart, for example as illustrated in FIG. 1, is implemented by transverse components above the wall components 20, for example in a manner of the aforesaid bridging component 160, and under water substantially beneath an energy field of ocean waves 40 propagating along the channels 50.

Tapering of the channels 50 along their lengths from the first side 110 to the second side 120, for example as illustrated in FIG. 2b, is beneficially dynamically adjustable, for example using side baffles along sides of the components 20, for coping with diverse ocean wave 40 conditions. The parallel wall components 20 function as energy-forming channels 50 and are provided with a row of floats 100 so that motion of the floats 100 is converted to electrical energy via apparatus which is mounted in respect of the planar wall components 20. Metal rod and metal band arrangements are beneficially employed for coupling motion energy from the floats 100 for electricity production purposes. Hydraulic, pneumatic and/or mechanical transmissions of energy from the floats 100 is optionally provided by the system 10. Modules and their associated channels 50 formed by the planar wall components 20 are beneficially furnished with automatic height and pitch adjustment by way of buoyancy adjustment, for example as elucidated earlier.

The system 10 is optionally provided with a wind turbine park, ocean stream turbines, for example to generate electricity from ocean currents flowing past the system 10, solar cells for generating electricity from solar energy received at the system 10, personnel accommodation and servicing modules, for example workshops whereat component parts of the system 10 can be serviced and repaired. The system 10 is also beneficially provided with a helicopter pad for personnel-transport purposes as well as a harbour area. On the second side 120 whereat a tranquil region of ocean 30 is provided, aquaculture 230 is susceptible to being undertaken, for example using water pumps functioning pursuant to a Venturi-principle. The system 10 also includes an anchorage arrangement for maintaining the system 10 in a given spatial position in the ocean 30; a possibility of orientating the system 10 in response to changing ocean wave 40 incident directions is advantageous to obtaining most efficient operation of the system 10.

Optionally, the channels 50 are at least partially covered in a semi-permeable membrane or netting, for example as represented by 1700, 1720 in FIG. 4a for the first and second sides 110, 120 respectively, for at least partially separating water included within the channels 50 from that of the ocean 30, but nevertheless allowing for efficient coupling of ocean waves 40 from the ocean 30 into the channels 50. Such an arrangement of semi-permeable membrane or netting is of benefit in that it does not interfere substantially with ocean wave propagation into the channels 50 but enables water of the channels 50 to be maintained more free of debris, for example seaweed and driftwood, which could otherwise interfere with energy coupling arrangements included within the channels 50.

In the foregoing, it is to be appreciated that ocean waves 40 have an energy field, for example as depicted in FIG. 7, which extend substantially down in a range of 25% to 50% of the ocean wave wavelength L. Large ocean waves are susceptible to having a wave peak-to-trough height of up to 35 metres, although a height of 10 to 20 metres height is more normal. The system 10 is beneficially designed to cope with such large wave amplitudes, for example in respect of dimensioning its component parts accordingly as elucidated in the foregoing.

In an anticipated implementation of the system 10, the system 10 optionally has a lateral extent transversely to the channels 50 in a range of 150 to 250 metres, and have a dimension X as provided in FIG. 2a in a range 50 to 100 metres, and a height of the planar components 20 over the ocean surface 550 in a range of 15 to 25 metres in operation. Other beneficial sizes for the planar components 20 are elucidated earlier in the foregoing.

An advantage provided by the system 10 is that it can be easily adapted for various coastal regions by combining fewer or greater number of planar components 20 to provide the system 10 with a required size and power generating capacity. Space within a volume of the planar components 20 can be employed as storage areas for materials and products manufactured at the system 10. Optionally, in operation only substantially 20% of a total extent of the planar components 20 is above the surface 550 of the ocean 30. At certain regions thereof, the planar components 20 are optionally relatively thin, namely in an order of 1 metre thick, but are then able to widen to regions having a thickness in a range of 3 to 5 metres or even more, for example for generating a tapered channel 50 as depicted in FIG. 2b.

The planar wall components 20 are conveniently optionally sub-divided into primary modules 1800, secondary modules 1810 and tertiary modules 1820, although the components 20 can otherwise be of integral construction as illustrated for example in FIG. 11. Optionally, the components 20 are each constructed by assembling primary, secondary and tertiary sub-units together. The primary modules 1800 are bearing elements of the system 10 and have a longest, deepest, most voluminous and massive form in comparison to the secondary and tertiary modules 1810, 1820 respectively. For example, the primary modules 1800 optionally have wind turbines 150 mounted thereto, as well as ocean current generating apparatus, for example implemented as one or more deeply-submerged open turbine propellers suspended beneath the system 10. The secondary modules 1810 are smaller than the primary modules 1800 and are adjacent thereto a depicted in FIG. 11. On account of the primary modules 1800 providing most protection against ocean waves 40 received by the system 10, the secondary and tertiary modules 1810, 1820 are at least partially protected by the primary modules 1800 and can therefore have various exposed structures, for example exposed vertical members, associated with energy conversion from motion of the floats 100 to electrical energy.

The tertiary modules 1820 have considerably less massive construction in comparison to the primary and secondary modules 1800, 1810. On account of shorter wavelength wave components of the ocean waves 40 propagating along the channels 50 and eventually reaching the tertiary modules 1820, the tertiary modules 1820 are optionally provided with diverse forms of shallowly-submerged elements designed to cause the shorter wavelength wave components to break for assisting energy extraction therefrom using the relatively smaller floats 100 included in the tertiary modules 1820.

It is envisaged that the system 10 beneficially has a mass in a range of 5 to 25000 tonnes in order to ensure a sufficient degree of robustness and stability against severe ocean weather, for example hurricane conditions experienced in the Pacific Ocean when not so passive. The system 10 is susceptible to being constructed from a combination of concrete, steel, aquatic-grade aluminium or aluminium alloy, composite materials, plastics materials, ceramics and glass as required.

Floats 100 within the channels 50 will have a natural damped frequency when they bob up and down in water when disturbed. Beneficially, the width of the channel 50 and the shape and mass of the floats 100 are designed to exhibit a damped resonant frequency of vertical motion which is matched to a propagating wave along the channel 50 to which they are most sensitive on account of the length of the floats 100 along the channel 50. By such resonant matching, greater movements of the floats 100 in response to waves 40 propagating along the channels 50 can be achieved and thereby more efficient conversion of movement of the floats 100 to electrical power produced by the system 10 when in operation.

The floats 100 are beneficially provided with a degree of freedom when moving up and down in response to ocean waves acting thereupon, for example to have a degree of lateral freedom of motion. Larger floats 100, for example associated with the primary modules 1800, can have tubular guides to assist restraining their lateral motion so that they do not impact onto sides of the channels 50. In certain implementations of the system 10, the channels 50 can have a width in a range of 3 to 7 metres. The largest floats 100(1) are beneficially fabricated from concrete, for example reinforced concrete with one or more embedded metal buoyancy tanks included therein.

In general, the floats 100 are susceptible to being fabricated from at least one of steel, aluminium and composite materials. For example, the floats 100 have a width in a range of 1 to 5 metres, and a height in a range of 1 to 2 metres. The floats 100 have, for example, a mass in a range of 3 to 25 tonnes in order to survive extreme ocean weather conditions. When constructed from lightweight materials, for example aluminium and/or composites, the floats 100 are susceptible to having a weight in a range of 1.5 to 10 tonnes. Lighter floats 100 in the secondary and tertiary modules 1810, 1820 respectively beneficially have a width in a range of 1 to 3 metres, and a height in a range of 0.5 to 1 metre, with an associated mass in a range of 1 to 3 tonnes. It is to be borne in mind that the smaller floats 100 within the system 10 associated with the secondary and tertiary modules 1810, 1820 are often susceptible in combination to providing more energy output than the larger floats 100 of the primary modules 1800 in moderate ocean weather conditions.

As elucidated in the foregoing, the front floats 100(1), and optionally other floats spatially near thereto, are capable of being “parked” in a lower portion of the system 10 by causing them to sink below substantially below the surface 550 of the ocean 30. Such parking of the front floats 100(1) is executed when ocean wave activities are too low for useful energy to be extracted from the front floats 100(1) so that smaller floats 100 have unimpeded access to the ocean 30. Similar considerations pertain to other larger floats, for example the float 100(2) that may be included within the primary modules 1800. The front floats 100(1) are capable of being redeployed by pumping out water from their one or more buoyancy tanks, for example in response to greater ocean wave heights H and longer wavelengths L being detected.

The inventor has appreciated that water lower down within the channels 50 undergoes a circular motion, for example as depicted in FIGS. 6 and 7, as ocean waves 40 propagate along the channels 50. Moreover, the inventor has envisaged that the system 10 beneficially includes additional submerged apparatus for extracting energy from waves propagating along the channels 50. The submerged apparatus beneficially is implemented as depicted in FIG. 7 within a lower region of a corresponding channel 50 and comprises a submerged float 1850 coupled via two pumps 1860 to transverse elements 1870 operable to maintain the planar wall components 20 at a desired distance apart. The two pumps 1860 are operable to pump seawater at high pressure through hoses to drive the aforementioned generator 680 whose alternating current output is coupled to a rectifier unit 690 and thereafter to a PWM converter unit 700 for providing electrical power to an electricity network (not shown). The submerged arrangement as depicted in FIG. 7 is susceptible to being employed in combination with the floats 100 as described in the foregoing to ensure highly effective extraction of wave energy from the channels 50. Optionally, the height of the submerged float 1850 within the channel 50 is dynamically variable in response to wave height within the channel 50. Beneficially the submerged float 1850 is implemented in the form of an elongate cylinder whose principal axis is orthogonal to a direction of the channel 50. As an alternative to employing the pumps 1860, motion of the float 1850 is conveyed via a mechanical lever arrangement to the generator 680, for example by a system of elongate rods and related couplings and pivots; such a mechanical arrangement is potentially more efficient at transmitting motion energy from the float 1850 to generate corresponding electrical power. Inclusion of the submerged float 1850 provides a synergistic benefit of causing waves propagating at the surface 550 along the channel to break, thereby assisting operation of the floats 100 when extracting wave energy.

In implementing the planar wall components 20, a possible form for the components 20 is, for example, provided in FIG. 11. The component 20 is susceptible to being modified so that only the tertiary module 1820 has its sidewalls extending above the surface 550 of the ocean 30, and the primary and secondary modules 1800, 1810 are shallowly submerged in operation but nevertheless able to form an effective channel region 50 as elucidated in the forgoing along which propagating waves 40 are suitably formed for energy extraction purposes, for example as illustrated in side view in FIG. 20. The channel region thereby formed selectively focus ocean waves 40 by way of channel tapering and submerged features operable to cause the waves 40 to break for energy extraction purposes via the floats 100. In an arrangement as illustrated in FIG. 20, components required for extracting energy, for example siphon ducts, pulleys, levers and such like, from the floats 100 in the primary and secondary modules 1800, 1820 beneficially project above the surface 550 of the ocean 30. In the arrangement of FIG. 20, the planar wall components 20 are optionally, when ocean weather conditions require, adjusted in their buoyancy so that the channels 50 have non-submerged sidewalls along their complete length. However, a normal mode of operation is perceived to be as depicted in FIG. 20 with only the tertiary module 1820 above the ocean surface 550.

The inventor envisages that ocean wave energy systems constructed pursuant to examples provided in the foregoing have a potential to become an industry standard on account of providing a most optimal compromise between robustness, ease of maintenance, effectiveness, and flexibility. With Norway having a coastline of substantially 1000 km length and an energy collection capacity approaching 70 kW/metre of coastline, off-shore deployment of the system 10 along Norway's coast could theoretically generate as much as 70 GigaWatts (GW) of energy supply which is sufficient to satisfy Europe's entire energy needs, including transport based upon electric traction, for example electric automobiles and electric trains. However, the system 10 is susceptible to being also deployed in many other sites around the World and potentially provides a practical permanent solution to mankind's future energy needs. Present World oil consumption corresponds to circa 80 million barrels of oil per day; in order to generate a corresponding amount of energy from renewable sources, spatially large renewable energy generation facilities are inevitably required. Apparatus of the present invention is consequently envisaged to be of considerable size and spatial extent.

Referring to FIG. 21a in conjunction with FIG. 1, the ocean wave energy system 10 is optionally implemented in conjunction with a bridge structure 2000 linking two land regions 2010, 2020 as illustrated; channels 50 of the energy system 10 are beneficially orthogonal to a general elongate axis of the bridge structure 2000. The bridge structure 2000 is beneficially implemented as a floating arrangement anchored to an ocean bed; optionally, the bridge structure 2000 is implemented as a plurality of floating sections coupled together in series along their elongate axes. Alternatively, the bridge structure 2000 is beneficially built up from the ocean bed, for example on concrete or steel pillars. The bridge structure 2000 beneficially includes one or more linking portions which are operable to be opened and closed for enabling ships 2040 to traverse the bridge structure 2000; alternatively, or additionally, the bridge structure 2000 includes submerged tunnels and/or suspension bridges for enabling ships 2040 to pass. The ocean wave energy system 10 is beneficially implemented at least along part of a length on at least one side of the bridge structure 2000, more preferably on both sides of the bridge structure 2000 as illustrated in FIG. 21a. Optionally, the bridge structure 2000 has a length in a range of 1 km to 10000 km, more preferable in a range of 2 km to 100 km; for example, the bridge structure 2000 could hypothetically be built between Europe and North America, with synergistic benefits of providing all Europe's and USA electrical energy needs from renewable energy sources, of providing aquaculture food production to provide for a significant portion of Europe's and USA's food needs, of providing a transport route such as a high-speed railway link between Europe and USA for reducing a need for aircraft transport, as well as enabling US and European electrical energy networks to be combined to provide greater security of electricity supply, for example in a manner akin to contemporary Nordpool. General Worldwide implementation of the present invention could therefore have profound effect on addressing climate change issues and servicing energy needs of the World's substantially exponentially-growing population.

When the bridge structure 2000 is 100 km long and furnished with ocean wave energy systems 10 on both sides thereof, the bridge structure 2000 is capable of generating in an order of at least 10 GW of electrical energy. At an energy production cost of NOK 1/kWh, such a 100 km-long bridge structure is capable of generating a revenue in an order of NOK 200 thousand million per day, representing an attractive investment, even before synergistic income from other types of facilities situated along the bridge structure 2000 are taken into consideration.

Referring to FIG. 21b, the bridge structure 2000 is beneficially provided with two transport routes and is arranged in an arcuate form with a region for aquaculture provided in one or more hoops provided in the bridge structure 2000. Optionally, the one or more hoops are provided with cross-members for supporting one or more wind turbines concurrently with aquaculture being executed thereat; the cross-members are operable to transfer stress forces from one side of the bridge structure 2000 to another side thereof, thereby increasing robustness of the bridge structure 2000. Such an implementation is more stable to lateral forces, enabling the bridge structure to survive severe hurricane conditions experienced in Asia and the Pacific ocean. During construction of the bridge structure 2000, the system 10 is beneficially progressively built out as two energy peninsula from the land regions 2010, the system 10 progressively providing more energy and aquaculture products as it is progressively constructed to provide return for investment, until the bridge structure 2000 is finally joined to the land regions 2010. A further advantage of such an energy peninsula when provided with a road transport route is that component parts to extend the peninsula can be transported along peninsula. Construction of such an energy peninsula is capable of providing considerable employment opportunities for people as it is progressively built out.

As aforementioned, the bridge structure 2000 and its associated ocean wave energy system 10 beneficially link countries and/or continents together, for example: between England and Ireland; between Spain and Morocco, thereby linking Europe and Africa together; between Greenland and Canada; between Denmark and Germany. Apart from optionally providing road and/or rail access between the two land regions 2010, 2020, the bridge structure 2000 is susceptible to providing an additional synergistic benefit of enabling power cables from the ocean wave energy system 10 to be conveyed onto one or more of the land regions 2010, 2020. Moreover, the bridge structure 2000 synergistically allows road access to the ocean wave energy system 10, for example for maintenance and repair purposes, as well as enabling raw materials to be transported to the ocean wave energy system 10 and completed products to be transported therefrom, for example when manufacturing industry and/or materials processing is performed locally along the bridge structure 2000 or adjacent thereto. Moreover, the bridge structure 2000 also synergistically enables worker access to such manufacturing industry and materials processing.

Beneficially, the bridge structure 2000 and/or its ocean wave energy systems 10 also synergistically includes wind turbines 150 constructed thereonto for generating electricity from wind flowing past the bridge structure 2000. Furthermore, aquaculture, for example salmon farming, in net containment cages is performed along the bridge structure 2000 in a more tranquil region of water between the ocean wave energy system 10 and the bridge structure 2000. Yet additional facilities can be included on and around the bridge structure 2000 to improve its economic viability, for example casino gambling facilities, hotel accommodation, artificial beaches, yachting marinas, health spas, massage parlours, acupuncture centres, arts studios, schools and colleges, conference centres, retailing and restaurant facilities such as sushi restaurants whereat aquaculture products are consumed. Moreover, the bridge structure 2000 is also synergistically beneficially provided with recharging facilities for recharging plug-in hybrid and purely electric vehicles travelling via the bridge structure 2000, namely the bridge structure 2000 is furnished with electrical recharging stations for vehicles including electric motor drivetrains. Furthermore, the bridge structure 2000 is synergistically beneficially provided with facilities for waste processing and disposal which are energy-intensive, for example neutralizing, drying and pulverising of waste before it is transported away by ship and/or rail and/or road transport for disposal. Additionally, the bridge structure 2000 in conjunction with its ocean wave energy system 10 is synergistically furnished with water processing facilities, for example osmotic-pressure water purification systems, for generating fresh water from saline water present in the ocean 30; the fresh water is beneficially conveyed via pipes to the two land regions 2010, 2020, for supporting agriculture on the land regions 2010, 2020. Such fresh water provision is potentially beneficial to Mediterranean countries and Australasian lacking rainfall due to adverse effects of climate change.

By synergistically combining the aforementioned ocean wave energy system 10 with the bridge structure 2000 and using such a combination as a platform for other facilities, for example aquaculture, potentially greatly increases the economic viability of the ocean wave energy system 10 which requires relatively large structures to be constructed to support its implementation and deployment as elucidated in the foregoing.

In conclusion, the present invention concerns an ocean wave energy system 10 for generating power from ocean waves 40, characterized in that the system 10 comprises:
(a) a plurality of wall components 20 defining one or more channels 50 for guiding propagation of ocean waves 40 therealong, each channel having a first end 110 for receiving the ocean waves and a second end 120 remote from the first end; and
(b) a float arrangement 100 and/or a submerged movable component arrangement (for example implemented using the submerged floats 1850) disposed along each of the one or more channels 50 between its first and second ends 110, 120, the float arrangement 100 and/or the submerged movable component arrangement being arranged to absorb energy from the ocean waves 40.

Optionally, the float arrangement 100 is operable to absorb energy from the ocean waves 40 from the first end 110 to the second end 120 commencing with longest wavelength components in the waves 40. Optionally, the submerged movable component arrangement, for example implemented via the submerged floats 1850, is operable to absorb energy from the ocean waves 40 from the first end 110 to the second end 120; such energy absorption beneficially commences with longest wavelength components in the waves 40. In one embodiment of the present invention, the float arrangement 100 is included for electrical energy generation from ocean waves, and the submerged moveable component arrangement is omitted. In another embodiment of the present invention, the float arrangement 100 is omitted and the submerged movable component arrangement is included for electrical energy generation from ocean waves. In yet another embodiment of the present invention, both the float arrangement 100 and the submerged movable component arrangement are both included for electric energy generation from ocean waves. Whereas the submerged movable component arrangement is better protected from damage by major ocean waves, for example in storm weather conditions, the float arrangement 100 is capable of provided for more efficient energy harvesting from ocean waves received at the system 10.

Although the ocean wave energy system 10 is described in the foregoing as comprising one or more channels 50 whose longitudinal axis are substantially parallel, the wave system 10 is optionally susceptible to being implemented so that its channels 50 are disposed in alternative configurations as illustrated in FIG. 22. Referring to FIG. 22, the channels 50 are beneficially implemented as a star formation indicated by 3000, in a skewed formation indicated by 3010, in a bowed formation indicated by 3020, in an elliptical formation indicated by 3030, in a rectangular formation indicated by 3040. For example, the ocean wave energy system 10 is susceptible to being implemented as a constellation of islands, each island including a plurality of the channels 50 and their associated floats 100, 1850 as required.

The planar wall components 20 synergistically include one or more gyroscopic stabilizers implemented using one or more fly-wheels 4000 connected to electric drive motors 4010 which are operable to spin the one or more fly-wheels 4000 at a high rate of revolution, for example in a range 1000 to 10000 revolutions per minute. Optionally, one or more fly-wheels 4000 are housed in at least partially evacuated enclosures for reducing air resistance. Such stabilization resists the planar wall components 20 from angularly rocking whilst simultaneously enabling the wall components 20 to be of relatively lighter construction whilst still remaining robust against storm weather conditions. Moreover, when the electric drive motors 4010 are also capable of functioning as generators for converting inertial energy of the one or more fly-wheels 4000 back to electrical energy, the one or more fly-wheels 4000 are beneficially employed for short-period energy storage for smoothing out temporal fluctuations in energy output from the wave energy system 10 when in operation. The one or more fly-wheels 4000 and their associated motors 4010 are beneficially additionally, or alternatively, mounted in the bridging member 160.

A problem with many renewable energy systems is that their power output is not constant on account of varying wind speeds and ocean wave amplitudes. Such variations have rendered hydroelectric power generation system and tidal power generation systems more attractive. In the case of wind turbines, it is generally recognized that only circa 20% of energy within a national or regional power generation network is beneficially generated by wind turbines, with reserve generating capacity in the form of fast-response gas turbines, water pump storage schemes (for example Dinorwic pump storage system) for example. Beneficially, the system 10 includes energy storage components 5000 within the planar wall components 20, so that the system 10 is capable of smoothing out variations in available wind and/or wave energy.

Energy storage in the planar wall components 20 is beneficially, for example, based upon polymer rechargeable lithium batteries, and/or upon compressed air energy storage. Such air energy storage based on compressed air beneficially utilizes technology developed by a French inventor Guy Negre as described in his patent applications which are herewith incorporated by reference; for example, inventor Guy Negre's patent applications include WO2006/136728A1 (PCT/FR2006/001444), WO2005/049968A1 (PCT/FR2004/002929), WO99/20881 (PCT/FR98/02227) amongst others. The planar wall components 20 beneficially includes high pressure pumps for pumping air at high pressure, for example up to 300 Bar or more, into air storage tanks housed within the planar wall components 20. The storage tanks are beneficially fabricated from robust materials such as carbon fibre. The high pressure pumps are operated from a portion of power generated by the system 10 from wind and/or wave energy, beneficially huge amounts of energy which are available in storm conditions. When the ocean 30 is relatively tranquil and/or wind speeds are relatively low, the system 10 is operable to generate electricity from energy stored within its planar wall components 20. For example, in tranquil weather conditions, compressed air in the air storage tanks is fed back to the high pressure pumps which are operable to function as air motors for driving electrical generators for generating electricity. The energy storage components 5000 optionally include one or more compressed air tanks 5010 located submerged substantially near a front end of the planar wall components 20 as illustrated in FIGS. 3,4a, 4b and 9. Such implementation of the compressed air tanks 5010 is of benefit in that the tanks 5010 can be employed for buoyancy control of the system 10, are well protected from impact or storm damage, and do not risk damaging the system 10 in an event that they unexpectedly explode or rupture; such mounting of the tanks 5010 are, for example, in a manner slightly akin to inventor Guy Negre's mounting of compressed air tanks on an underside of a chassis of his air-propelled road vehicles. The one or more compressed air tanks 5010 are beneficially of streamlined bullet-like shape so that they enclose a relatively larger volume for a given amount of wall material utilized, and are structurally stronger. Alternatively, or additionally, the tanks 5010 are mounted in a more tranquil region of water behind the channels 50 remote from the front first floats 100(1) so that they are well protected from severe weather conditions whilst not posing a significant safety hazard. Yet more optionally, the floats 100 themselves are synergistically employed as compressed-gas energy storage tanks pursuant to principles of energy storage proposed by inventor Guy Negre; by such synergistic use of the floats 100, the system 10 can be constructed in a most compact manner, thereby enabling more channels 50 to be accommodated for a given degree of investment in the system 10.

Expressions such as “has”, “is”, “include”, “comprise”, “consist of”, “incorporates” are to be construed to include additional components or items which are not specifically defined; namely, such terms are to be construed in a non-exclusive manner. Moreover, reference to the singular is also to be construed to also include the plural. Furthermore, numerals and other symbols included within parentheses in the accompanying claims are not to be construed to influence interpreted claim scope but merely assist in understanding the present invention when studying the claims.

Modifications to embodiments of the invention described in the foregoing are susceptible to being implemented without departing from the scope of the invention as defined by the appended claims.

1. An ocean wave energy system for generating power from ocean waves, wherein said system comprises:
(a) a plurality of wall components defining one or more channels for guiding propagation of ocean waves therealong, each channel having a first end for receiving the ocean waves and a second end remote from the first end; and
(b) a float arrangement and/or submerged movable component arrangements disposed along each of the one or more channels between its first and second ends, at least one of the float arrangement and submerged movable component arrangement being arranged in size to progressively absorb energy from the ocean waves commencing with longest wavelength components in the waves and finishing with shortest wavelength components in the waves.

2. An ocean wave energy system as claimed in claim 1, wherein the system comprises a power coupling arrangement associated with the float arrangement, the power coupling arrangement being mounted in respect of the plurality of wall components, the power coupling arrangement being operable to generate power by converting motion of the float arrangement in response to the ocean waves propagating along the one or more channels.

3. An ocean wave energy system as claimed in claim 1, wherein the float arrangement comprises one or more floats for each of said one or more channels, said one or more floats being selectively deployable for controlling wave frequency ranges from which energy is extracted from ocean waves propagating along the one or more channels.

4. An ocean wave energy system as claimed in claim 1, wherein said plurality of wall components comprise buoyancy arrangements for enabling at least one of their height and inclination relative to an ocean surface to be adjusted in operation.

5. An ocean wave energy system as claimed in claim 1, wherein said one or more channels are formed in shape along their length for concentrating propagating ocean wave energy therealong in operation.

6. An ocean wave energy system as claimed in claim 1, comprising one or more submerged features for causing ocean waves received at the system to at least one of break and spatially synchronize as they enter into the one or more channels.

7. An ocean wave energy system as claimed in claim 1, comprising one or more submerged features along said one or more channels for at least one of:
(a) extracting energy from cyclical water movement associated with an underwater energy field of waves propagating along the channels; and
(b) causing ocean waves propagating along the channels to break for assistance energy collection by said float arrangement from said one or more channels.

8. An ocean wave energy system as claimed in claim 1, wherein said plurality of wall components is more massively constructed in a region thereof in a vicinity of said first end in comparison to said second end.

9. An ocean wave energy system as claimed in claim 1, comprising transverse members disposed at least under said one or more channels and over said one or more channels for maintaining said plurality of wall components in a spaced-apart configuration for defining said one or more channels.

10. An ocean wave energy system as claimed in claim 9, wherein additional facilities are included mounted on at least one of said transverse members and said plurality of wall components, said additional facilities comprising at least one of:
(a) cranes for servicing the float arrangement of the one or more channels;
(b) wind turbines for wind power generation;
(c) solar energy collection arrangements for solar power generation; and
(d) one or more helicopter landing pads.

11. An ocean wave energy system as claimed in claim 1, comprising additional facilities at the second end of the one or more channels, said additional facilities comprising at least one of:
(a) aquaculture;
(b) harbour facilities;
(c) personnel facilities; and
(d) visitor/tourist facilities.

12. An ocean wave energy system as claimed in claim 2, wherein said power coupling arrangement comprises one or more primary liquid tanks mounted in respect of said one or more wall components, one or more secondary liquid tanks mounted in respect of floats of said float arrangement, and one or more siphon ducts operable to fluidly couple between respective said one or more primary liquid tanks and said one or more secondary liquid tanks, said one or more siphon ducts comprising one or more turbines for extracting energy from liquid flow occurring in operation within the one or more ducts in response to movement of the one or more floats relative to their respective one or more wall components.

13. An ocean wave energy system as claimed in claim 2, wherein said power coupling arrangement is operable to utilize at least one of:
(a) a configuration of at least one of levers and pulleys for coupling movement of floats of said float arrangement to a power generator arrangement; and
(b) a configuration of permanent electromagnets and electrical coils mounted in respect of floats of the float arrangement and mounted in respect of the one or more wall components so that movement of the floats in operation relative to the one or more wall components generates electrical power directly.

14. An ocean wave energy system as claimed in claim 1, wherein at least one of said plurality of wall components comprises one or more energy storage arrangements for storing a portion of energy generated by the system, and for converting energy stored therein into electricity when said system is subject to at least one of reduced wind speed and ocean wave amplitude for maintaining a more stable supply of energy from said system wherein in operation.

15. An energy peninsula comprising at least one end coupled to at least one land region, said energy peninsula including at least one ocean wave energy system as claimed in claim 1.

16. A method of generating power from ocean waves in an ocean wave energy system, said method comprising:
(a) using a plurality of wall components defining one or more channels for guiding propagation of ocean waves therealong, each channel having a first end for receiving the ocean waves and a second end remote from the first end; and
(b) using a float arrangement arranged in suitable size and disposed along each of the one or more channels between its first and second ends and/or using a submerged movable component arrangement disposed along each of the one or more channels between its first and second ends, progressively absorbing energy from the ocean waves commencing with longest wavelength components in the waves and finishing with shortest wavelength components in the waves.

17. A method of controlling operation of an ocean wave energy system as claimed in claim 1, said method comprising:
(a) sensing a frequency spectrum of wave components present in ocean waves received at the system; and
(b) selectively deploying one or more floats of a float arrangement in response to said frequency spectrum, taking into consideration spatial wavelength response characteristics of said one or more floats to wave components present in said received ocean waves.

18. A method as claimed in claim 17, comprising selectively retracting one or more of said floats to a submerged state when said one or more of said floats are not required in respect of said sensed frequency spectrum.

19. A software product stored on a data carrier and capable of being machine read and executed on computing hardware for implementing a method as claimed in claim 16.

20. A method of extracting power in a power coupling arrangement comprising one or more primary liquid tanks mounted in respect of one or more wall components, one or more secondary liquid tanks mounted in respect of floats of a float arrangement, and one or more siphon ducts operable to fluidly couple between respective said one or more primary liquid tanks and said one or more secondary liquid tanks, said method comprising:
using one or more turbines included in said one or more siphon ducts for extracting energy from liquid flow occurring in operation within the one or more ducts in response to movement of the one or more floats relative to their respective one or more wall components.

21. A bridge structure linking two land regions together, said bridge structure having disposed therealong an ocean wave energy system as claimed in claim 1.
